(19) United States
(12) Patent Application Publication
(10) Pub. No.: US 2025/0026130 A1
(43) Pub. Date: Jan. 23, 2025

(54) LIQUID DISCHARGE APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventors: TAKAO OGATA, Tokyo (JP); KEITA ISHIMI, Kanagawa (JP); AKIHIRO TOMIDA, Kanagawa (JP); YOSHIYUKI HONDA, Kanagawa (JP); AKIHIRO MOURI, Tokyo (JP); RIE TAKEKOSHI, Kanagawa (JP); TOSHIMITSU DANZUKA, Tokyo (JP); AKIKO AICHI, Tokyo (JP)

(21) Appl. No.: 18/778,621

(22) Filed: Jul. 19, 2024

(30) Foreign Application Priority Data
Jul. 20, 2023 (JP) 2023-118513
Jul. 4, 2024 (JP) 2024-108398

(51) Int. Cl. B41J 2/175; B41J 2/045; B41J 2/17; B41J 2/18

(52) U.S. Cl. CPC B41J 2/17596; B41J 2/04553; B41J 2/04581; B41J 2/1707; B41J 2/18

(57) ABSTRACT

A liquid discharge apparatus includes a discharging head including a nozzle configured to discharge a liquid; a circulation pump provided in the discharge head and configured to supply the liquid to the nozzle, the pump being configured to circulate the liquid; and a control unit configured to control driving of the circulation pump. The control unit is configured to switch a driving condition of the circulation pump to change a flow velocity of the liquid during a circulation period of the liquid.

### BACKGROUND OF THE INVENTION

### Field of the Invention

The present invention relates to a control technique of a liquid discharge apparatus.

### Description of the Related Art

As an example of a liquid discharge apparatus, a printing apparatus that discharges ink and prints an image on a print medium is known. In the printing apparatus, a phenomenon that an ink concentration or an ink viscosity increases due to evaporation of a volatile component of ink from the orifices of nozzles sometimes occurs. This phenomenon affects the quality of a printed image. To prevent this, there is proposed a technique of circulatively supplying ink to nozzles (for example, Japanese Patent Laid-Open Nos. 2021-169224 and 2017-140807).

Circulation of ink is performed in, for example, a printing operation. If the time of circulation stop is long, sedimentation of a solid component progresses, and a circulation time for eliminating the sedimentation may be long. If the flow velocity of ink at the time of circulation is increased, the sedimentation can be eliminated in a relatively short circulation time. However, this may increase the load on a circulation pump, resulting in a decrease of the life of the circulation pump or an increase of power consumption.

### SUMMARY OF THE INVENTION

The present invention provides a technique capable of eliminating sedimentation of a solid component in a relatively short time while suppressing a load on a circulation pump.

According to an aspect of the present invention, there is provided a liquid discharge apparatus comprising: a discharging head including a nozzle configured to discharge a liquid; a circulation pump provided in the discharge head and configured to supply the liquid to the nozzle, the pump being configured to circulate the liquid; and a control unit configured to control driving of the circulation pump, wherein the control unit is configured to switch a driving condition of the circulation pump to change a flow velocity of the liquid during a circulation period of the liquid.

Further features of the present invention will become apparent from the following description of exemplary embodiments (with reference to the attached drawings).

### BRIEF DESCRIPTION OF THE DRAWINGS

FIG. 1 is an explanatory view of a liquid discharge apparatus;

FIG. 2 is an explanatory view of the internal mechanism of the liquid discharge apparatus shown in FIG. 1;

FIG. 3 is a block diagram of the control unit of the liquid discharge apparatus shown in FIG. 1;

FIG. 4 is an explanatory view of a recovery unit;

FIG. 5 is an exploded perspective view of a discharging head;

FIG. 6A is a longitudinal sectional view of the discharging head;

FIG. 6B is an enlarged sectional view of a discharge module;

FIG. 7 is a schematic view of a circulation unit;

FIG. 8 is a longitudinal sectional view showing a circulation path;

FIG. 9 is a block diagram of the circulation path;

FIGS. 10A to 10C are explanatory views of a pressure adjustment mechanism;

FIGS. 11A and 11B are perspective views showing the outer appearance of a circulation pump;

FIG. 12 is a sectional view of the circulation pump taken along a line IX-IX in FIG. 11A;

FIGS. 13A and 13B are exploded perspective views of the circulation pump;

FIG. 14 is a view showing an electrical connecting portion of a piezoelectric ceramic viewed from the side of a drive circuit board through the drive circuit board;

FIGS. 15A to 15E are views for explaining the flow of ink in the discharging head;

FIGS. 16A and 16B are schematic views showing a circulation path in a discharge unit;

FIG. 17 is an explanatory view of an opening plate;

FIG. 18 is an explanatory view of a discharge element substrate;

FIGS. 19A to 19C are sectional views of the discharge unit showing an ink flow;

FIGS. 20A and 20B are sectional views showing the vicinity of an orifice;

FIGS. 21A and 21B are sectional views showing the vicinity of an orifice according to a comparative example;

FIG. 22 is a view showing a comparative example of the discharge element substrate;

FIGS. 23A and 23B are views showing the flow passage configuration of the discharging head;

FIG. 24A is a flowchart showing an example of control processing of the circulation pump;

FIG. 24B is a view showing an example of a drive pattern selection table;

FIGS. 25A and 25B are timing charts showing examples of the drive pattern of the circulation pump;

FIGS. 26A to 26D are explanatory views showing an example of an ink flowing mode;

FIGS. 27A to 27C are timing charts showing examples of the drive pattern of the circulation pump;

FIGS. 28A to 28C are timing charts showing examples of the drive pattern of the circulation pump;

FIGS. 29A and 29B are timing charts showing examples of the drive pattern of the circulation pump;

FIG. 30A is a flowchart showing an example of control processing of the circulation pump;

FIG. 30B is a view showing an example of selection of a drive pattern; and

FIGS. 31A to 31C are timing charts showing examples of the drive pattern of the circulation pump.

FIG. 32 is a view showing a relationship between a driving time and an effect.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### <Outline of Liquid Discharge Apparatus>

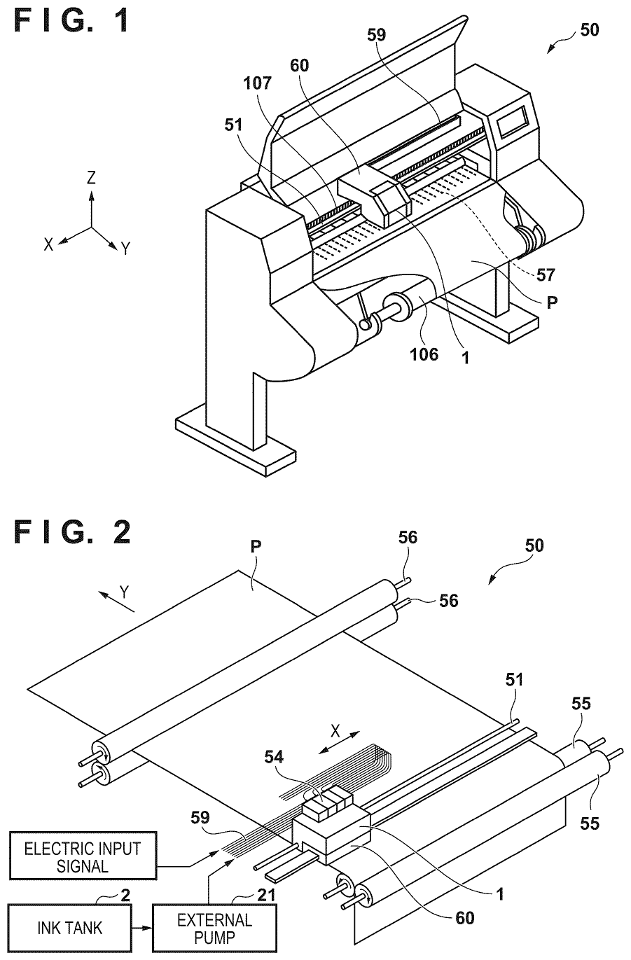

FIG. 1 is a view showing the outer appearance of a liquid discharge apparatus 50 according to an embodiment of the present invention. FIG. 2 is an explanatory view of the internal mechanism of the liquid discharge apparatus 50. In the views, arrows X, Y, and Z indicate directions crossing each other. In this embodiment, the arrows X and Y indicate horizontal directions orthogonal to each other, showing the widthwise direction and the depth direction of the liquid discharge apparatus 50, and the arrow Z indicates a vertical direction (height direction).

The liquid discharge apparatus 50 according to this embodiment is an inkjet printing apparatus that discharges ink as a liquid to a print medium and prints an image on the print medium. In this embodiment, a case where the present invention is applied to a serial type inkjet printing apparatus will be described. The X direction is the reciprocating direction (main scan direction) of a carriage 60, and the Y direction is the conveyance direction (sub-scan direction) of a print medium P. Note that the present invention can be applied to a printing apparatus of another type.

In this embodiment, a description will be made using an example in which a discharge element that discharges a liquid employs a thermal method of discharging a liquid by causing an electrothermal transducer to generate bubbles. However, the present invention is not limited to this. The present invention can also be applied to a discharging head that employs a discharge method of discharging a liquid using a piezoelectric element or another discharge method.

Also, “printing” includes not only formation of significant information such as a character or a figure but also formation of an image, a design, a pattern, or the like on a print medium in a broad sense or processing of a medium regardless of whether information is significant or insignificant, or whether information is so visualized as to allow the user to visually perceive it. Also, in this embodiment, a “print medium” is assumed to be paper in a sheet form but may be cloth, a plastic film, or the like.

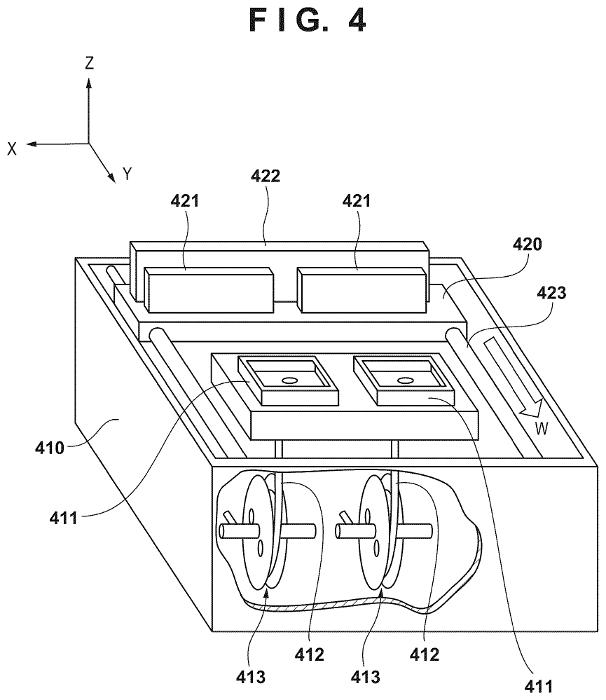

The liquid discharge apparatus 50 includes a discharging head 1 that discharges ink as a liquid. The discharging head 1 is mounted on the carriage 60. The discharging head 1 is configured to be attachable/detachable to/from the carriage 60 by a user. The carriage 60 moves in the X direction along a guide shaft 51. A recovery unit 410 (see FIG. 4) that is not shown in FIGS. 1 and 2 is provided in the moving range of the carriage 60. The recovery unit 410 maintains and recovers the liquid discharge performance of the discharging head 1.

During printing, the print medium P is conveyed on a platen 57 in the Y direction by a conveyance roller pair 55 and a conveyance roller pair 56. One roller of the conveyance roller pair 55 is a driving roller, and the other is a driven roller (for example, a pinch roller). Similarly, one roller of the conveyance roller pair 56 is a driving roller, and the other is a driven roller (for example, a pinch roller).

The liquid discharge apparatus 50 is provided with an ink tank 2 that is an ink supply source, and an external pump 21. Ink stored in the ink tank 2 is supplied to the discharging head 1 via an ink supply tube 59 by the driving force of the external pump 21. The discharging head 1 can discharge, for example, four types of inks, that is, black (K), cyan (C), magenta (M), and yellow (Y) inks, and a full-color image can be printed by these inks. The discharging head 1 is controlled by receiving an electrical signal via an electrical cable (not shown).

The discharging head 1 is provided with a circulation unit 54. The circulation unit 54 is a unit that circulates ink. In this embodiment, four circulation units 54 according to the four types of inks are provided in the discharging head 1. The circulation unit 54 may be provided in accordance with each type of liquid to be discharged, or a plurality of circulation units 54 may be provided for the same type of liquid. That is, the discharging head 1 can include one or more circulation units 54.

The printing operation of the liquid discharge apparatus 50 is started when the print medium P is fed by a feeding mechanism (not shown) from a spool 106 that holds the print medium P. The printing operation is performed by alternately repeating an intermittent conveyance operation of the print medium P and a print scan operation. The intermittent conveyance operation is an operation of conveying the print medium P by a predetermined amount and then stopping it, and this operation is performed by the conveyance roller pairs 55 and 56. The print scan operation is an operation of, in a state in which conveyance of the print medium P is stopped, discharging ink while moving the carriage 60 to move the discharging head 1 in the widthwise direction of the print medium P. In the print scan operation, the position of the carriage 60 is specified by reading an encoder 107 by an encoder sensor (not shown) provided on the carriage 60. Printing of an image on the print medium P progresses by the printing operation.

Note that in this embodiment, a so-called serial type printing apparatus has been exemplified. However, it may be a printing apparatus using a full-line type discharging head capable of discharging ink all over the print medium P in the widthwise direction.

### <Control Unit>

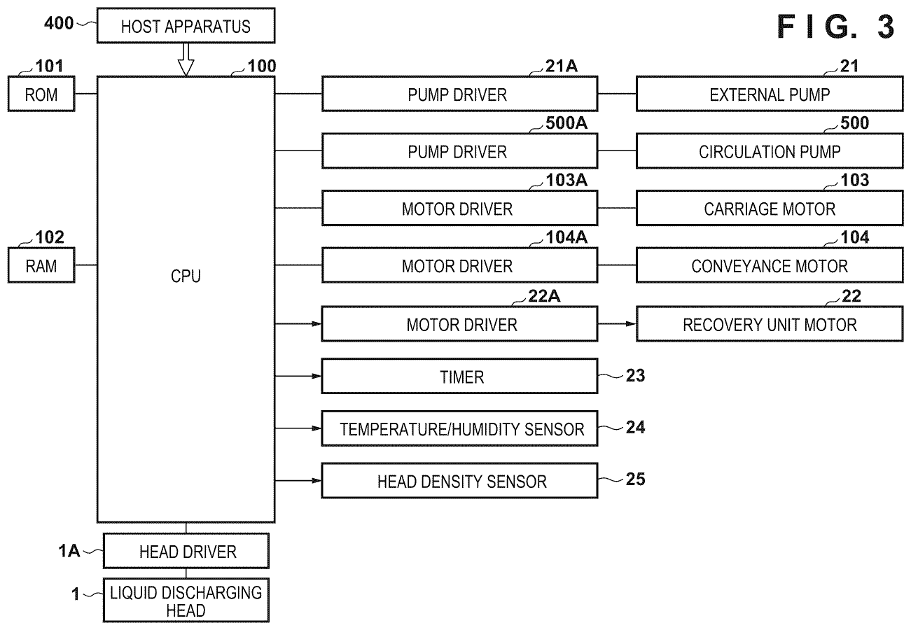

FIG. 3 is a block diagram of the control unit of the liquid discharge apparatus 50. A CPU 100 controls the operations of the units of the liquid discharge apparatus 50 based on the program of a processing procedure or the like stored in a ROM 101. A RAM 102 is used as a work area when the CPU 100 executes processing. The CPU 100 receives image data from a host apparatus 400 outside the liquid discharge apparatus 50 and controls a head driver 1A, thereby controlling driving of discharge elements provided in the discharging head 1.

In addition, the CPU 100 controls drivers of various actuators provided in the liquid discharge apparatus 50. For example, the CPU 100 controls a motor driver 103A of a carriage motor 103 that is a driving source configured to move the carriage 60, and a motor driver 104A of a conveyance motor 104 configured to convey the print medium P. Also, for example, the CPU 100 controls a motor driver 22A of a recovery unit motor 22. The moving mechanism of the carriage 60 is, for example, a belt transmission mechanism, and the carriage 60 can be moved by fixing it to an endless belt travelling by the driving force of the carriage motor 103. The recovery unit motor 22 is a motor mounted in the recovery unit 410. Furthermore, the CPU 100 controls a pump driver 500A that drives a circulation pump 500 to be described later, and a pump driver 21A of the external pump 21.

A head temperature sensor 25 is provided on the discharging head 1 and detects the temperature of discharging head 1. A temperature/humidity sensor 24 detects the temperature and humidity in the environment around the liquid discharge apparatus 50, that is, the air temperature and humidity in the installation space of the liquid discharge apparatus 50. A timer 23 measures time.

### <Configuration of Recovery Unit>

FIG. 4 is a schematic view of the recovery unit 410. A cap 411 is supported such that it can be lifted by a lifting mechanism (not shown), and moves between a rise position and a lowering position. At the rise position, the cap 411 contacts the discharging head 1 and covers (caps) the nozzle surface (ink discharge surface) thereof. The cap 411 covers the nozzle surface of the discharging head 1, thereby forming a substantially closed space. This can suppress drying of the nozzles of the discharging head 1 and evaporation of ink in a nonprinting operation. Also, the ink can be sucked from the discharging head 1 via the cap 411 by driving a suction pump 413 to be described later.

In the printing operation, the cap 411 is located at the lowering position to avoid interference to the discharging head 1 that moves together with the carriage 60. In a state in which the cap 411 is located at the lowering position, the discharging head 1 can perform preliminary discharge to the cap 411 when it moves to a position facing the cap 411.

Wipers (wiper blades) 421 and 422 are each made of an elastic member such as rubber. In this embodiment, the two wipers 421 apart in the X direction and the wiper 422 that wipes the whole nozzle surface are provided.

The wipers 421 and 422 are fixed to a wiper holder 420. The wiper holder 420 can move along guides 423 in the front-back direction (the array direction of the nozzles in the discharging head 1) indicated by an arrow W in FIG. 4. When the discharging head 1 is located on the recovery unit 410, the wiper holder 420 moves in the direction of the arrow W (one direction), thereby performing a wiping operation by the wipers 421 and 422 wiping the nozzle surface while being contact with the nozzle surface. When the wiping operation is ended, the carriage 60 is moved and retreated from the region where the wiping operation is performed, and the wiper holder 420 is then moved to return the wipers 421 and 422 to the original position (the position before the wiping operation).

Note that in this embodiment, each wiper is formed by an elastic member such as rubber, but may be formed by a member made of a porous material that absorbs ink. A vacuum wiper configuration capable of sucking the nozzle surface is also possible. Alternatively, a configuration that performs wiping by pressing a nonwoven fabric against the nozzle surface may be adopted. In this embodiment, wiping is performed only when the wipers move in one direction. However, a configuration that performs wiping when the wipers move in both directions of reciprocating may be adopted. In this embodiment, the wiping direction is the array direction of the nozzles in the discharging head 1. However, the wipers may move in a direction (the arrangement direction of nozzle arrays) crossing (orthogonal to) that direction. In this configuration, the wipers may be fixed, and the carriage 60 may scan in the scan direction to wipe the nozzle surface.

The suction pump 413 is driven in a state in which the cap 411 covers the nozzle surface of the discharging head 1 to form a substantially closed space inside, and thus generates a negative pressure in the cap 411, thereby performing a suction operation of sucking ink from the discharging head 1. The suction operation is performed when filling ink from the ink tank into the discharging head 1 (at the time of initial filling) or when sucking and removing dust, sticking matters, and bubbles in the nozzles (at the time of suction recovery). The cap 411 is connected to a waste ink absorber (not shown) via a flexible tube 412.

In this embodiment, a tube pump is used as the suction pump 413. The tube pump includes a holding portion with a curved surface portion that holds (at least a part of) the tube 412 along it, a roller capable of pressing the held tube 412, and a roller support portion that rotatably supports the roller. The tube pump rotates the roller support portion in a predetermined direction, thereby rotating the roller while pressing the tube 412. A negative pressure is thus generated in the cap 411, and the ink is sucked from the discharging head 1. The sucked ink is discharged to the waste ink absorber (not shown) via the tube 412.

When the discharging head 1 performs preliminary discharge to the cap 411, the suction operation is performed to discharge the ink accepted by the cap 411 by the preliminary discharge. That is, if the ink held in the cap 411 upon preliminary discharge reaches a predetermined amount, the suction pump 413 is driven, thereby discharging the ink held in the cap 411 to the waste ink absorber via the tube 412.

### <Structure of Discharging Head>

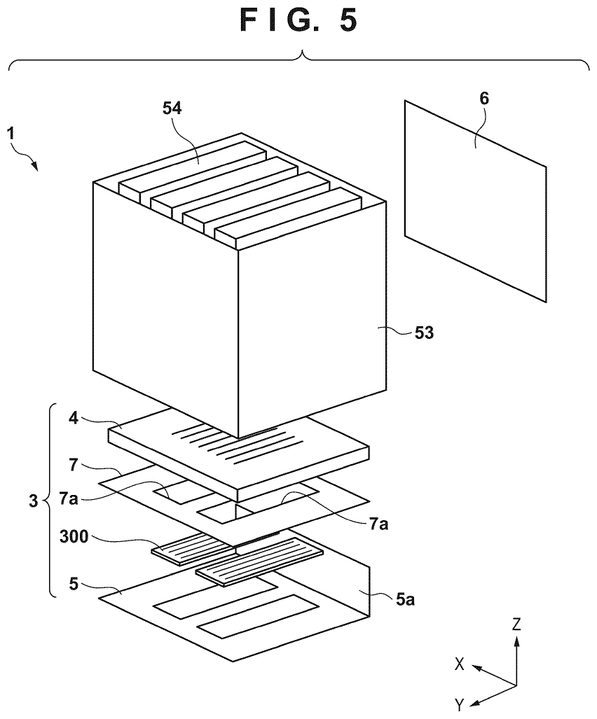

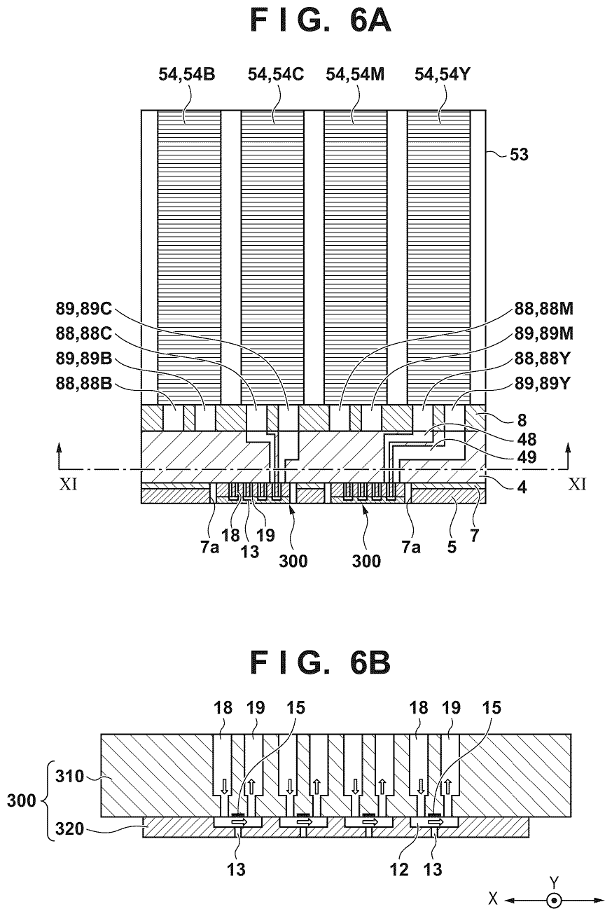

The structure of the discharging head 1 will be described with reference to FIGS. 5, 6A, and 6B in addition to FIG. 2. FIG. 5 is an exploded perspective view of the discharging head 1. FIGS. 6A and 6B are longitudinal sectional views of the discharging head 1. FIG. 6A is a longitudinal sectional view of the entire discharging head 1, and FIG. 6B is an enlarged view of a discharge module 300.

The discharging head 1 includes the circulation unit 54, and a discharge unit 3 configured to discharge ink supplied from the circulation unit 54 to the print medium P. The external pump 21 connected to the ink tank 2 serving as an ink supply source is provided with an ink supply tube 59 (see FIG. 2). A liquid connector (not shown) is provided at the distal end of the ink supply tube 59. When the discharging head 1 is mounted in the liquid discharge apparatus 50, the liquid connector provided at the distal end of the ink supply tube 59 is hermetically connected to a liquid connector insertion port (not shown) provided in a head housing 53 of the discharging head 1.

This forms an ink supply path from the ink tank 2 to the discharging head 1 via the external pump 21. In this embodiment, four types of inks are used. For this reason, four sets of ink tanks 2, external pumps 21, ink supply tubes 59, and circulation units 54 are provided, and four ink supply paths corresponding to the inks are formed independently.

Thus, the liquid discharge apparatus 50 according to this embodiment is provided with an ink supply system that supplies ink from the ink tank 2 provided outside the discharging head 1. Note that the liquid discharge apparatus 50 according to this embodiment does not include an ink recovery system that recovers ink in the discharging head 1 to the ink tank 2.

FIG. 6A shows the circulation units 54 discriminatively for each ink type. That is, the discharging head 1 is provided with a circulation unit 54B for black ink, a circulation unit 54C for cyan ink, a circulation unit 54M for magenta ink, and a circulation unit 54Y for yellow ink. The circulation units 54B, 54C, 54M, and 54Y have substantially the same configuration, and the circulation units 54B, 54C, 54M, and 54Y will simply be referred to as the circulation unit 54 if these are not particularly discriminated in this embodiment.

The discharge unit 3 forms a plurality of nozzles for discharging ink. Each nozzle includes a pressure chamber 12, an orifice 13, and a discharge element 15. The discharge unit 3 includes two discharge modules 300, a first support member 4, a second support member 7, an electric wiring member (electric wiring tape) 5, and an electric contact substrate 6. The discharge module 300 includes a silicon substrate 310 having a thickness of about 0.5 to 1 mm, and a plurality of discharge elements 15 provided on one surface of the silicon substrate 310. The discharge element 15 according to this embodiment is formed by an electrothermal transducer (heater) that generates thermal energy as discharge energy for discharging a liquid. Power is supplied to each discharge element 15 via an electric wire formed on the silicon substrate 310 by a deposition technique. An orifice forming member 320 is arranged on the surface (the lower surface in FIG. 6B) of the silicon substrate 310. In the orifice forming member 320, a plurality of pressure chambers 12 corresponding to the plurality of discharge elements 15, and a plurality of orifices 13 configured to discharge ink are formed by photolithography.

In the silicon substrate 310, individual supply flow passages 18 and individual recovery flow passages 19 communicating with the pressure chambers 12 are formed. In this embodiment, one discharge module 300 is configured to discharge two types of inks. That is, of the two discharge modules 300 shown in FIG. 6A, the discharge module 300 located on the left side of FIG. 6A discharges the black ink and the cyan ink, and the discharge module 300 located on the right side of FIG. 6A discharges the magenta ink and the yellow ink. Furthermore, in the example shown in FIG. 6A, two orifice arrays extending in the Y direction are formed in correspondence with one color ink. The pressure chamber 12, the individual supply flow passage 18, and the individual recovery flow passage 19 are formed for each of the plurality of orifices 13 forming the orifice arrays.

Ink supply ports and ink recovery ports to be described later are formed in the back surface (the upper surface in FIG. 6B) of the silicon substrate 310. The ink supply ports supply ink from an ink supply flow passage 48 to the plurality of individual supply flow passages 18, and the ink recovery ports recover ink from the plurality of individual recovery flow passages 19 to an ink recovery flow passage 49.

Note that the ink supply ports and the ink recovery ports here indicate openings for supplying and recovering ink in ink circulation in the forward direction to be described later. That is, at the time of ink circulation in the forward direction, ink is supplied from the ink supply ports to the individual supply flow passages 18, and simultaneously, ink is recovered from the individual recovery flow passages 19 to the ink recovery ports. At the time of ink circulation for flowing ink in a direction reverse to the forward direction, ink is supplied from the ink recovery ports to the individual recovery flow passages 19, and simultaneously, ink is recovered from the individual supply flow passages 18 to the ink supply ports.

As shown in FIG. 6A, the discharge module 300 is adhered and fixed, at its back surface (the upper surface in FIG. 6A), to one surface (the lower surface in FIG. 6A) of the first support member 4. In the first support member 4, the ink supply flow passages 48 and the ink recovery flow passages 49 extending from the one surface to the other surface are formed. One opening of the ink supply flow passage 48 communicates with the above-described ink supply port in the silicon substrate 310, and one opening of the ink recovery flow passage 49 communicates with the above-described ink recovery port in the silicon substrate 310. Note that the ink supply flow passage 48 and the ink recovery flow passage 49 are provided for each ink type independently.

The second support member 7 including openings 7a (see FIG. 5) for receiving the discharge modules 300 is adhered and fixed to the other surface (the upper surface in FIG. 6A) of the first support member 4. The second support member 7 holds the electric wiring member 5 to be electrically connected to the discharge modules 300. The electric wiring member 5 is a member configured to supply an electrical signal for discharging ink to the discharge modules 300. The electrical connecting portions between the discharge modules 300 and the electric wiring member 5 are sealed by a sealing member and thus protected from corrosion by ink or external impact.

The electric contact substrate 6 is thermally press-fitted to an end portion 5a (see FIG. 5) of the electric wiring member 5 using an anisotropic conductive film (not shown), and the electric wiring member 5 and the electric contact substrate 6 are electrically connected to each other. The electric contact substrate 6 includes an external signal input terminal (not shown) configured to receive an electrical signal from the liquid discharge apparatus 50.

Furthermore, a joint member 8 (FIG. 6A) is provided between the first support member 4 and the circulation unit 54. In the joint member 8, a supply port 88 and a recovery port 89 are formed for each ink type. The supply port 88 and the recovery port 89 have a role of making the ink supply flow passage 48 and the ink recovery flow passage 49 of the first support member 4 communicate with the flow passage formed in the circulation unit 54. Note that in FIG. 6A, a supply port 88B and a recovery port 89B correspond to the black ink, and a supply port 88C and a recovery port 89C correspond to the cyan ink. Also, a supply port 88M and a recovery port 89M correspond to the magenta ink, and a supply port 88Y and a recovery port 89Y correspond to the yellow ink.

Note that the openings of the ink supply flow passage 48 and the ink recovery flow passage 49 of the first support member 4 on one end side have a small opening area according to the ink supply port and the ink recovery port in the silicon substrate 310. On the other hand, the openings of the ink supply flow passage 48 and the ink recovery flow passage 49 of the first support member 4 on the other end side have a shape obtained by enlarging the opening area to the same opening area as the large opening area of the joint member 8 formed in accordance with the flow passage of the circulation unit 54. When this configuration is employed, an increase of the flow passage resistance to ink collected from each recovery flow passage can be suppressed.

In the discharging head 1 having the above-described configuration, the ink supplied to the circulation unit 54 flows from the ink supply port of the discharge module 300 into the individual supply flow passage 18 via the supply port 88 of the joint member 8 and the ink supply flow passage 48 of the first support member 4. The ink then flows from the individual supply flow passage 18 into the pressure chamber 12, and a part of the ink that flows into the pressure chamber 12 is discharged from the orifice 13 by driving the discharge element 15. The ink remaining without being discharged flows from the pressure chamber 12 and flows from the ink recovery port into the ink recovery flow passage 49 of the first support member 4 via the individual recovery flow passage 19. Then, the ink that flows into the ink recovery flow passage 49 flows into the circulation unit 54 via the recovery port 89 of the joint member 8 and is recovered.

### <Structure of Circulation Unit>

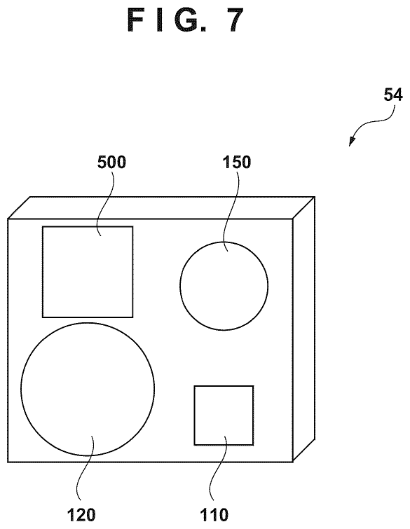

FIG. 7 is a schematic view of the circulation unit 54. The circulation unit 54 shown in FIG. 7 indicates one circulation unit 54 corresponding to one type of ink, and the circulation units 54B, 54C, 54M, and 54Y have the same structure as the circulation unit 54 shown in FIG. 7.

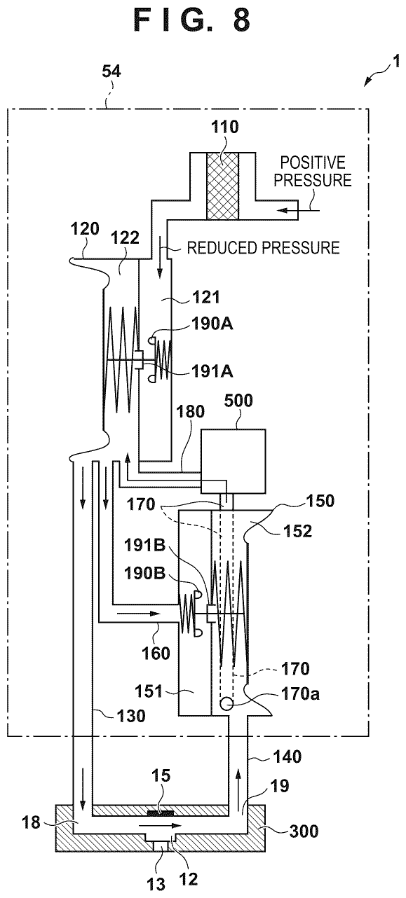

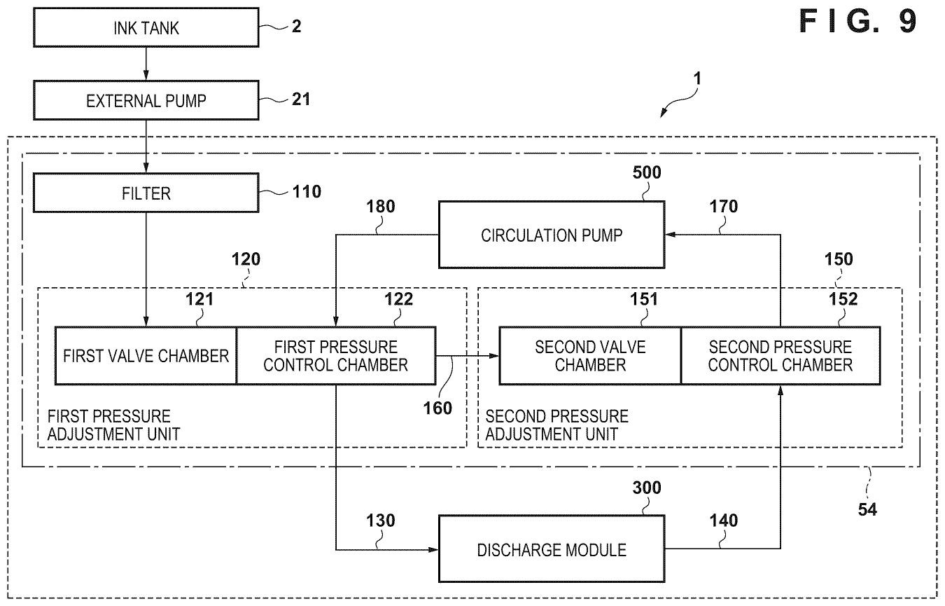

The circulation unit 54 includes a filter 110, a first pressure adjustment mechanism 120, a second pressure adjustment mechanism 150, and the circulation pump 500 that generates a circulation flow. These constituent elements are connected by flow passages, as shown in FIGS. 8 and 9, to form, in the discharging head 1, a circulation path (circulation flow passage) configured to perform supply and recovery of ink for the discharge module 300.

FIG. 8 is a longitudinal sectional view schematically showing the circulation path of one type of ink (one color ink), which is formed in the discharging head 1. FIG. 9 is a block diagram schematically showing the circulation path in FIG. 8.

The first pressure adjustment mechanism 120 includes a first valve chamber 121 and a first pressure control chamber 122. The second pressure adjustment mechanism 150 includes a second valve chamber 151 and a second pressure control chamber 152. The first pressure adjustment mechanism 120 is configured to have a control pressure higher than in the second pressure adjustment mechanism 150. In this embodiment, circulation of ink in the circulation path is implemented within a predetermined pressure range by using the two pressure adjustment mechanisms 120 and 150.

The circulation path is configured to make the ink flow near the pressure chamber 12 (the discharge element 15) with a flow amount according to the pressure difference between the first pressure adjustment mechanism 120 and the second pressure adjustment mechanism 150. The circulation path in the discharging head 1 and the flow of ink in the circulation path will be described below. Note that arrows in the drawings indicate the direction in which ink flows.

The connection state of the constituent elements in the discharging head 1 will be described first. The external pump 21 that sends the ink stored in the ink tank 2 provided outside the discharging head 1 to the discharging head 1 is connected to the circulation unit 54 via the ink supply tube 59 (FIG. 2). The filter 110 is provided in the ink flow passage located on the upstream side of the circulation unit 54. The ink flow passage located on the downstream side of the filter 110 is connected to the first valve chamber 121 of the first pressure adjustment mechanism 120. The first valve chamber 121 communicates with the first pressure control chamber 122 via a communication port 191A to be opened/closed by a valve 190A shown in FIG. 8.

The first pressure control chamber 122 is connected to a supply flow passage 130, a bypass flow passage 160, and a pump outlet flow passage 180 of the circulation pump 500. The supply flow passage 130 is connected to the individual supply flow passage 18 via the ink supply port provided in the discharge module 300. Also, the bypass flow passage 160 is connected to the second valve chamber 151 provided in the second pressure adjustment mechanism 150. The second valve chamber 151 communicates with the second pressure control chamber 152 via a communication port 191B to be opened/closed by a valve 190B shown in FIG. 8.

The second pressure control chamber 152 is connected to a recovery flow passage 140. The recovery flow passage 140 is connected to the individual recovery flow passage 19 via the ink recovery port provided in the discharge module 300. Also, the second pressure control chamber 152 is connected to the circulation pump 500 via a pump inlet flow passage 170. Note that in FIG. 8, a flow-in port 170a indicates the flow-in port of the pump inlet flow passage 170.

The flow of ink in the discharging head 1 will be described next. As shown in FIG. 9, the ink stored in the ink tank 2 is pressurized by the external pump 21 provided in the liquid discharge apparatus 50 and supplied as a positive pressure ink flow to the circulation unit 54 of the discharging head 1. The ink supplied to the circulation unit 54 passes through the filter 110 to remove foreign substances such as dust, and then flows into the first valve chamber 121 provided in the first pressure adjustment mechanism 120. At this time, the pressure of the ink is reduced from the positive pressure to a negative pressure.

Next, the flow of ink in the circulation path will be described. The circulation pump 500 operates to send the ink sucked from the pump inlet flow passage 170 on the upstream side to the pump outlet flow passage 180 on the downstream side. When the circulation pump 500 is driven, the ink supplied to the first pressure control chamber 122 flows into the supply flow passage 130 and the bypass flow passage 160 together with the ink fed from the pump outlet flow passage 180.

Note that, as will be described later in detail, in this embodiment, a piezoelectric diaphragm pump using a piezoelectric element adhered to a diaphragm as a driving source is used as the circulation pump 500. The piezoelectric diaphragm pump is a pump that changes the capacity in a pump chamber by inputting a driving voltage to the piezoelectric element, and alternately operates two check valves by pressure variation, thereby feeding a liquid.

The ink that flows into the supply flow passage 130 flows from the ink supply port of the discharge module 300 into the pressure chamber 12 via the individual supply flow passage 18, and a part of the ink is supplied to the orifice 13 and discharged from the orifice 13 by driving the discharge element 15 (generating heat). The ink remaining without being used for discharge flows in the pressure chamber 12 and passes through the individual recovery flow passage 19, and then flows into the recovery flow passage 140 connected to the discharge module 300. The ink that flows into the recovery flow passage 140 flows into the second pressure control chamber 152 of the second pressure adjustment mechanism 150.

On the other hand, the ink that flows into the bypass flow passage 160 flows into the second valve chamber 151 and then flows into the second pressure control chamber 152 via the communication port 191B. The ink that flows into the second pressure control chamber 152 via the bypass flow passage 160 and the ink recovered from the recovery flow passage 140 are sucked into the circulation pump 500 via the pump inlet flow passage 170 by driving the circulation pump 500.

The ink sucked into the circulation pump 500 is sent to the pump outlet flow passage 180 and flows into the first pressure control chamber 122 again. From then on, the ink that flows from the first pressure control chamber 122 into the second pressure control chamber 152 via the supply flow passage 130 and the discharge module 300 and the ink that flows into the second pressure control chamber 152 via the bypass flow passage 160 flow into the circulation pump 500. The ink is then sent from the circulation pump 500 to the first pressure control chamber 122. Circulation of ink in the circulation path is thus performed.

As described above, the ink can be circulated through the circulation path including the discharge module 300 by the circulation pump 500 provided in the circulation path. This makes it possible to suppress an increase of the viscosity of ink and deposition of a sedimentary component of ink of a color material in the discharge module 300 and also keep satisfactory fluidity of ink in the discharge module 300 and a satisfactory discharge characteristic at the orifice.

Also, since the ink need not be circulated outside the discharging head 1, a small pump can be used as the circulation pump 500, and size reduction of the apparatus can be implemented. A configuration that circulates the ink even through path outside the discharging head 1 can also be adopted.

### <Pressure Adjustment Mechanism>

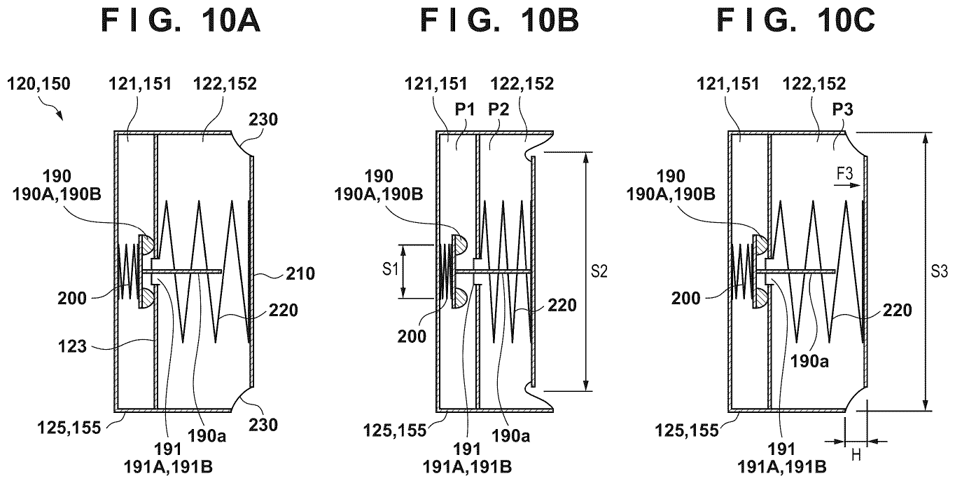

The configuration and function of the first pressure adjustment mechanism 120 and the second pressure adjustment mechanism 150 will be described in more detail with reference to FIGS. 10A to 10C. Note that since the first pressure adjustment mechanism 120 and the second pressure adjustment mechanism 150 have the same configuration, a description will be made using the first pressure adjustment mechanism 120 as an example. As for the second pressure adjustment mechanism 150, the same reference numerals are added to portions corresponding to the first pressure adjustment mechanism 120 in FIGS. 10A to 10C. In a case of the second pressure adjustment mechanism 150, the first valve chamber 121 to be described below can be replaced with the second valve chamber 151, and the first pressure control chamber 122 can be replaced with the second pressure control chamber 152.

The first pressure adjustment mechanism 120 includes the first valve chamber 121 and the first pressure control chamber 122 formed in a cylindrical housing 125. The first valve chamber 121 and the first pressure control chamber 122 are partitioned by a partition 123 provided in the cylindrical housing 125. The first valve chamber 121 communicates with the first pressure control chamber 122 via a communication port 191 formed in the partition 123.

The first valve chamber 121 is provided with a valve 190 that switches communication and block between the first valve chamber 121 and the first pressure control chamber 122 in the communication port 191. The valve 190 is held, by a valve spring 200, at a position facing the communication port 191, and can come into close contact with the partition 123 by the biasing force of the valve spring 200. When the valve 190 comes into close contact with the partition 123, the ink flow in the communication port 191 is blocked.

Note that, to improve the close contact with the partition 123, the contact portion of the valve 190 to the partition 123 may be formed by an elastic member.

A valve shaft 190a inserted into the communication port 191 projects from the center portion of the valve 190. When the valve shaft 190a is pressed against the biasing force of the valve spring 200, the valve 190 separates from the partition 123, enabling flow of ink in the communication port 191. A state in which the ink flow in the communication port 191 is blocked by the valve 190 will be referred to as a “closed state”, and a state in which the ink flow in the communication port 191 is possible will be referred to as an “open state” hereinafter.

The opening portion of the cylindrical housing 125 is closed by a flexible member 230 and a pressure plate 210. The first pressure control chamber 122 is formed by the flexible member 230, the pressure plate 210, the peripheral wall of the housing 125, and the partition 123. The pressure plate 210 is configured to be displaced along with the displacement of the flexible member 230. Although the materials of the pressure plate 210 and the flexible member 230 are not particularly limited, for example, the pressure plate 210 can be formed by a resin molded component, and the flexible member 230 can be formed by a resin film. In this case, the pressure plate 210 can be fixed to the flexible member 230 by heat welding.

A pressure adjustment spring 220 is provided between the pressure plate 210 and the partition 123. The pressure plate 210 and the flexible member 230 are biased by the biasing force of the pressure adjustment spring 220 in a direction of expanding the internal capacity of the first pressure control chamber 122. If the pressure in the first pressure control chamber 122 decreases, the pressure plate 210 and the flexible member 230 are displaced in a direction of decreasing the internal capacity of the first pressure control chamber 122 against the pressure of the pressure adjustment spring 220. If the internal capacity of the first pressure control chamber 122 decreases to a predetermined amount, the pressure plate 210 contacts the valve shaft 190a of the valve 190. After that, if the internal capacity of the first pressure control chamber 122 further decreases, the valve 190 moves and separates from the partition 123 together with the valve shaft 190a against the biasing force of the valve spring 200. The communication port 191 is thus set in the open state.

In this embodiment, the pressure in the first valve chamber 121 when the communication port 191 is in the open state is designed to be higher than the pressure in the first pressure control chamber 122. Hence, if the communication port 191 is in the open state, the ink flows from the first valve chamber 121 into the first pressure control chamber 122. As the ink flows in, the flexible member 230 and the pressure plate 210 are displaced in a direction of increasing the internal capacity of the first pressure control chamber 122. As a result, the pressure plate 210 separates from the valve shaft 190a of the valve 190, the communication port 191 contacts the partition 123 by the biasing force of the valve spring 200, and the communication port 191 is set in the closed state.

In the first pressure adjustment mechanism 120 according to this embodiment, if the pressure in the first pressure control chamber 122 decreases to a predetermined pressure or less (for example, if the negative pressure increases), the ink flows from the first valve chamber 121 via the communication port 191. The first pressure adjustment mechanism 120 is thus configured to prevent the pressure in the first pressure control chamber 122 from further decreasing. Hence, control is performed such that the first pressure control chamber 122 is kept in a pressure within a predetermined range.

The pressure in the first pressure control chamber 122 will be described next in more detail. Consider a state in which, as described above, the flexible member 230 and the pressure plate 210 are displaced in accordance with the pressure in the first pressure control chamber 122, the pressure plate 210 contacts the valve shaft 190a, and the communication port 191 is set in the open state (the state shown in FIG. 10B). At this time, the relationship of forces acting on the pressure plate 210 is expressed as

P2×S2+F2+(P1−P2)×S1+F1=0 (1)

Furthermore, if equation (1) is written concerning P2, we obtain

P2=−(F1+F2+P1×S1)/(S2−S1) (2)
P1: the pressure (gauge pressure) in the first valve chamber 121
P2: the pressure (gauge pressure) in the first pressure control chamber 122
F1: the spring force of the valve spring 200
F2: the spring force of the pressure adjustment spring 220
S1: the pressure receiving area of the valve 190
S2: the pressure receiving area of the pressure plate 210

Here, for the spring force F1 of the valve spring 200 and the spring force F2 of the pressure adjustment spring 220, a direction of pressing the valve 190 and the pressure plate 210 is defined as positive (the rightward direction in FIGS. 10A to 10C). Also, the pressure P1 in the first valve chamber 121 and the pressure P2 in the first pressure control chamber 122 are configured such that P1 holds a relationship given by P1≥P2.

The pressure P2 in the first pressure control chamber 122 when the communication port 191 is in the open state is decided by equation (2). When the communication port 191 is set in the open state, the ink flows from the first valve chamber 121 into the first pressure control chamber 122 because P1≥P2. As a result, the pressure P2 in the first pressure control chamber 122 does not decrease anymore, and P2 is maintained at a pressure in the predetermined range.

On the other hand, as shown in FIG. 10C, when the pressure plate 210 is in a noncontact state with respect to the valve shaft 190a, and the communication port 191 is in the closed state, the relationship of forces acting on the pressure plate 210 can be expressed as

$$P 3 \times S 3 + F 3 = 0 \qquad ( 3 )$$

If equation (3) is written concerning P3, we obtain

$$P 3 = - F 3 / S 3 \qquad ( 4 )$$

F3: the spring force of the pressure adjustment spring 220 when the pressure plate 210 and the valve shaft 190a are in a noncontact state
P3: the pressure (gauge pressure) in the first pressure control chamber 122 when the pressure plate 210 and the valve shaft 190a are in a noncontact state
S3: the pressure receiving area of the pressure plate 210 when the pressure plate 210 and the valve shaft 190a are in a noncontact state

Here, FIG. 10C shows a state in which the pressure plate 210 and the flexible member 230 are displaced in the rightward direction in FIG. 10C up to a displacement limit. The pressure P3 in the first pressure control chamber 122, the spring force F3 of the pressure adjustment spring 220, and the pressure receiving area S3 of the pressure plate 210 change in accordance with the displacement amount during the displacement of the pressure plate 210 and the flexible member 230 to the state shown in FIG. 10C.

More specifically, if the pressure plate 210 and the flexible member 230 are located on the left side as compared to FIG. 10C, the pressure receiving area S3 of the pressure plate 210 becomes small, and the spring force F3 of the pressure adjustment spring 220 becomes large. As a result, the pressure P3 in the first pressure control chamber 122 decreases because of the relationship of equation (4).

Hence, by equations (2) and (4), during the time until the state shown in FIG. 10B changes to the state shown in FIG. 10C, the pressure in the first pressure control chamber 122 gradually rises (that is, the negative pressure weakens and obtains a value approaching the positive pressure side). That is, the pressure plate 210 and the flexible member 230 are gradually displaced in the rightward direction from a state in which the communication port 191 is in the open state, and until the internal capacity of the first pressure control chamber 122 finally reaches the displacement limit, the pressure in the first pressure control chamber gradually rises. That is, the negative pressure weakens.

### <Circulation Pump>

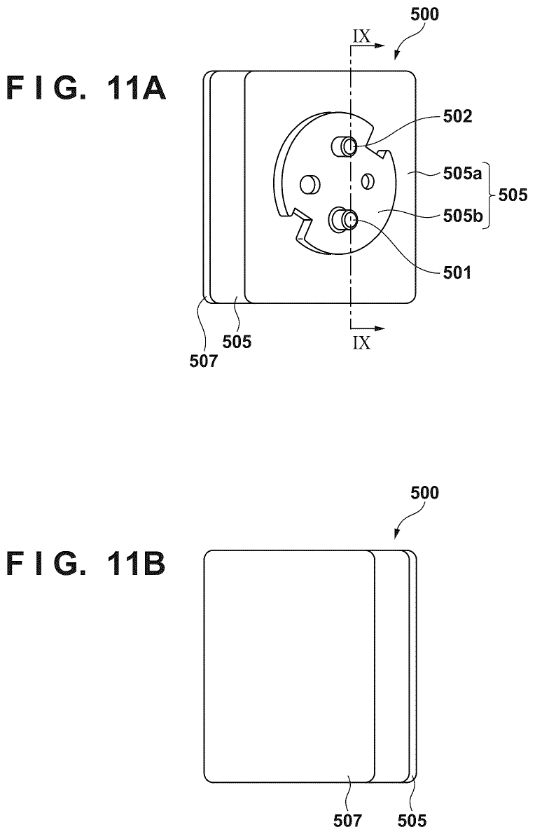

Next, the configuration and function of the circulation pump 500 will be described in detail with reference to FIGS. 11A, 11B, and 12. FIGS. 11A and 11B are perspective views showing the outer appearance of the circulation pump 500. FIG. 11A is a perspective view showing the outer appearance of the circulation pump 500 on the front side, and FIG. 11B is a perspective view showing the outer appearance of the circulation pump 500 on the rear side.

The exterior of the circulation pump 500 is formed by a pump housing 505, and a cover 507 fixed to the pump housing 505. The pump housing 505 is formed by a housing portion main body 505a, and a flow passage connecting member 505b adhered and fixed to the outer surface of the housing portion main body 505a.

In each of the housing portion main body 505a and the flow passage connecting member 505b, a pair of through holes communicating with each other are provided at two positions different from each other. One of the pair of through holes provided at one position forms a pump supply hole 501, and the other of the pair of through holes provided at the other position forms a pump discharge hole 502.

The pump supply hole 501 is connected to the pump inlet flow passage 170 connected to the second pressure control chamber 152. The pump discharge hole 502 is connected to the pump outlet flow passage 180 connected to the first pressure control chamber 122. Ink supplied from the pump supply hole 501 is discharged from the pump discharge hole 502 via a pump chamber 503 to be described later.

FIG. 12 is a sectional view of the circulation pump 500 taken along a line IX-IX in FIG. 11A. A diaphragm 506 is jointed to the inner surface of the pump housing 505, and the pump chamber 503 is formed between the diaphragm 506 and a concave portion formed in the inner surface of the pump housing 505.

The pump chamber 503 communicates with the pump supply hole 501 and the pump discharge hole 502 formed in the pump housing 505. A check valve 504a is provided in the intermediate portion of the pump supply hole 501, and a check valve 504b is provided at the intermediate portion of the pump discharge hole 502.

More specifically, the check valve 504a is arranged such that a part of the check valve 504a can move to the left side in FIG. 12 in a space 512a formed in the intermediate portion of the pump supply hole 501. The check valve 504b is arranged such that a part of the check valve 504b can move to the right side in FIG. 12 in a space 512b formed in the intermediate portion of the pump discharge hole 502.

If the diaphragm 506 is displaced to increase the capacity of the pump chamber 503, and the pressure in the pump chamber 503 is thus reduced, the check valve 504a separates from the opening of the pump supply hole 501 in the space 512a (that is, moves to the left side in FIG. 12). When the valve 504a separates from the opening of the pump supply hole 501 in the space 512a, an open state in which the ink flow in the pump supply hole 501 is possible is obtained.

If the diaphragm 506 is displaced to decrease the capacity of the pump chamber 503, and the pressure in the pump chamber 503 is thus raised, the check valve 504a contacts the wall surface around the opening of the pump supply hole 501, and a closed state in in which ink flow in the pump supply hole 501 is blocked is obtained.

If the pressure in the pump chamber 503 is reduced, the check valve 504b contacts the wall surface around the opening of the pump housing 505, and a closed state in in which ink flow in the pump discharge hole 502 is blocked is obtained. If the pressure in the pump chamber 503 is raised, the check valve 504b separates from the opening of the pump housing 505 and moves to the side of the space 512b (that is, moves to the right side in FIG. 12), thereby enabling ink flow in the pump discharge hole 502.

Note that the check valves 504a and 504b need only be made of a material that can be deformed in accordance with the pressure in the pump chamber 503, and can be formed by, for example, an elastic member such as EPDM or elastomer, a film such as a polypropylene film, or a thin plate. However, the material is not limited to these.

The pump chamber 503 is formed by joining the pump housing 505 and the diaphragm 506. Hence, when the diaphragm 506 is deformed, the pressure in the pump chamber 503 changes.

For example, if the diaphragm 506 is displaced to the side of the pump housing 505 (displaced to the right side in FIG. 12), and the capacity of the pump chamber 503 is decreased, the pressure in the pump chamber 503 rises. Accordingly, the check valve 504b arranged facing the pump discharge hole 502 is set in the open state, and the ink in the pump chamber 503 is discharged. At this time, the check valve 504a arranged facing the pump supply hole 501 contacts the wall surface around the pump supply hole 501, and backflow of the ink from the pump chamber 503 to the pump supply hole 501 is suppressed.

Conversely, if the diaphragm 506 is displaced in a direction of expanding the pump chamber 503, the pressure in the pump chamber 503 decreases. Accordingly, the check valve 504a arranged facing the pump supply hole 501 is set in the open state, and the ink is supplied to the pump chamber 503. At this time, the check valve 504b arranged in the pump discharge hole 502 contacts the wall surface around the opening formed in the pump housing 505 to close the opening. Hence, backflow of the ink from the pump discharge hole 502 to the pump chamber 503 is suppressed.

As described above, in the circulation pump 500, the diaphragm 506 is deformed to change the pressure in the pump chamber 503, thereby sucking and discharging the ink. At this time, in a case where bubbles are mixed into the pump chamber 503, even if the diaphragm 506 is displaced, the pressure change in the pump chamber 503 is small because of expansion/contraction of the bubbles, and the liquid feed amount decreases.

To prevent this, the pump chamber 503 is arranged in parallel to the gravity such that bubbles mixed into the pump chamber 503 easily gather to the upper portion of the pump chamber 503, and the pump discharge hole 502 is arranged above the center of the pump chamber 503. This makes it possible to improve the discharging property of bubbles in the pump and stabilize the flow amount.

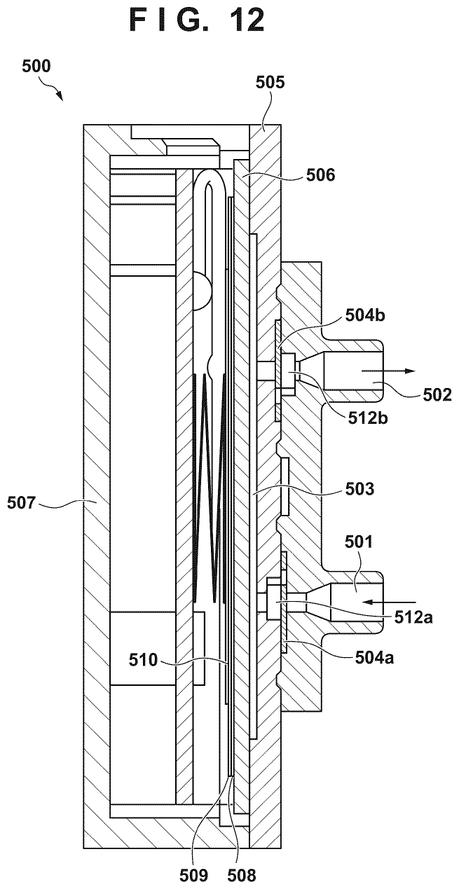

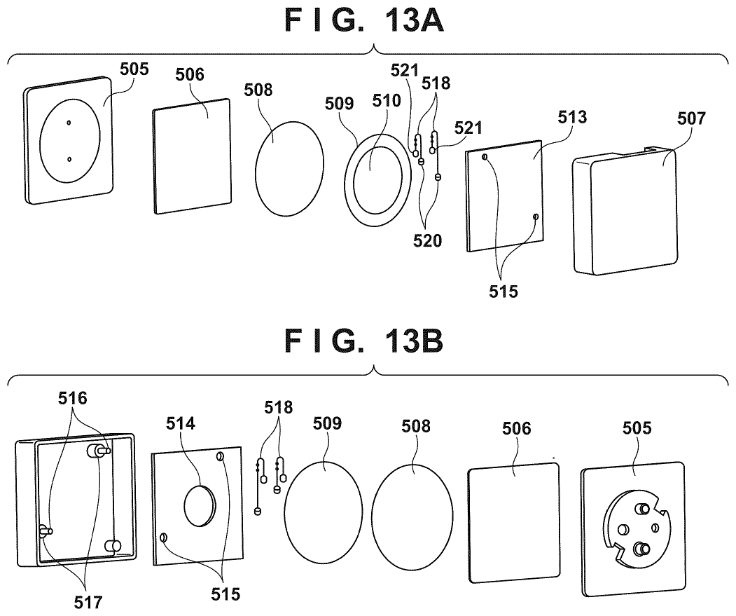

A driving unit that displaces the diaphragm 506 will be described next with reference to FIGS. 13A, 13B, and 14.

FIGS. 13A and 13B are exploded perspective views of the circulation pump 500. The circulation pump 500 is a piezoelectric pump that is driven by applying a voltage to a piezoelectric ceramic. A vibration plate 509 is adhered to the diaphragm 506 by an adhesive 508, and a piezoelectric ceramic 510 is fixed to the vibration plate 509 by adhering.

For the diaphragm 506, an injection moldable material such as modified PPE+PS or polypropylene can be used. However, a member formed by punching a film or a resin plate may be used, but the material is not limited to these. For the vibration plate 509, brass, stainless steel, an iron-nickel alloy, or the like can be used, but the material is not limited to these.

A drive circuit board 513 is provided on a surface facing the piezoelectric ceramic 510. The drive circuit board 513 receives power supplied from the power supply of the liquid discharge apparatus 50 and applies a voltage to the piezoelectric ceramic 510 and the vibration plate 509, thereby driving these. FIG. 14 is a view showing an electrical connecting portion of the piezoelectric ceramic 510 viewed from the side of the drive circuit board 513 through the drive circuit board 513.

The drive circuit board 513, the piezoelectric ceramic 510, and the vibration plate 509 are electrically connected to by electric connection cables 518. The electric connection cables 518 and the drive circuit board 513 are fixed and electrically connected by solder 521, and the electric connection cables 518, the piezoelectric ceramic 510, and the vibration plate 509 are fixed and electrically connected by solder 520.

The vibration plate 509 is connected to the GND wire of the drive circuit board 513 via the electric connection cable 518, and the piezoelectric ceramic 510 is connected to the AC voltage output portion of the drive circuit board 513 via the electric connection cable 518.

The vibration plate 509 is connected to the GND, and an AC voltage is applied to the piezoelectric ceramic 510, thereby expanding/contracting the piezoelectric ceramic 510 and deforming the diaphragm. This changes the pressure in the pump chamber to suck/discharge the ink.

The drive circuit board 513 is electrically connected to the electric contact substrate 6 (FIG. 5) by a cable, and a pump driving electric connection terminal is provided on the electric contact substrate 6. When the carriage 60 is attached, an electrical signal from the electric contact portion on the side of the carriage 60 is input to the pump driving electric connection terminal and the electrical signal is input to the drive circuit board 513 via the electric contact substrate 6. When the pump driving electric connection terminal is provided on the electric contact substrate 6, the circulation pump 500 can be driven by applying a predetermined voltage to the electric connection terminal even in a detached state from the carriage.

### <Flow of Ink in Discharging Head>

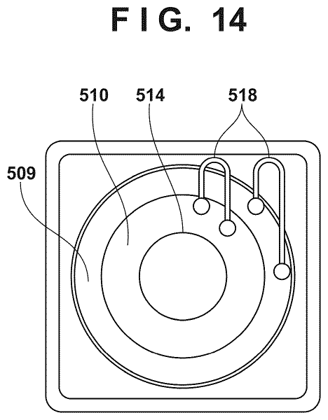

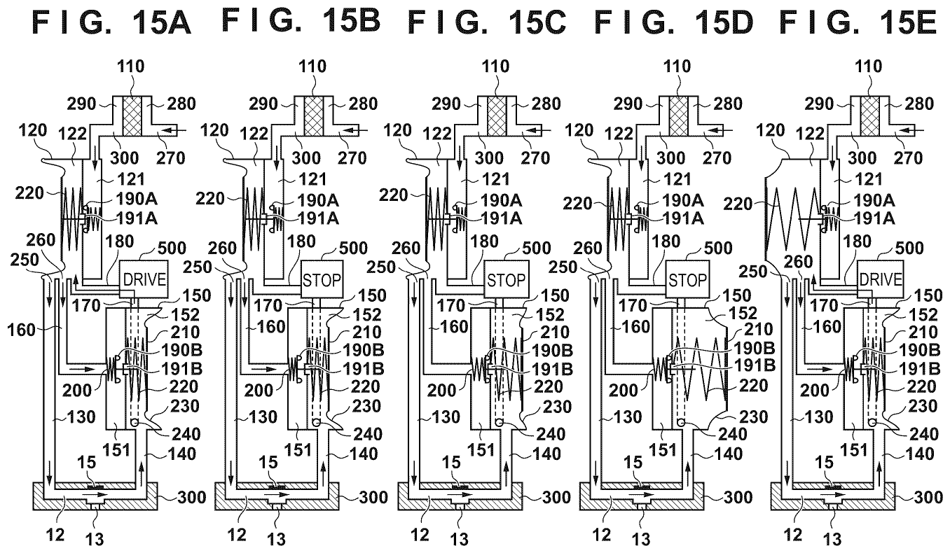

Ink circulation performed in the discharging head 1 will be described. FIGS. 15A to 15E are views for explaining the flow of ink in the discharging head 1.

FIG. 15A schematically shows the flow of ink when the printing operation is being performed. Arrows in FIG. 15A indicate the flow of ink. In this embodiment, when performing the printing operation, both the external pump 21 and the circulation pump 500 start driving. Note that the external pump 21 and the circulation pump 500 may be driven independently of the printing operation. Also, the external pump 21 and the circulation pump 500 may be driven not cooperatively but separately/independently.

During the printing operation, the circulation pump 500 is in an ON state (driving state), and the ink flowed out from the first pressure control chamber 122 flows into the supply flow passage 130 and the bypass flow passage 160. The ink that flows into the supply flow passage 130 passes through the discharge module 300 and then flows into the recovery flow passage 140 and is then supplied to the second pressure control chamber 152.

On the other hand, the ink that flows from the first pressure control chamber 122 into the bypass flow passage 160 flows into the second pressure control chamber 152 via the second valve chamber 151. The ink that flows into the second pressure control chamber 152 passes through the pump inlet flow passage 170, the circulation pump 500, and the pump outlet flow passage 180 and then flows into the first pressure control chamber 122 again.

At this time, the control pressure by the first valve chamber 121 is set to be higher than the control pressure of the first pressure control chamber 122 in accordance with the relationship of equation (2) described above. Hence, the ink in the first pressure control chamber 122 is supplied to the discharge module 300 via the supply flow passage 130 without flowing to the first valve chamber 121. The ink that flows into the discharge module 300 flows into the first pressure control chamber 122 again via the recovery flow passage 140, the second pressure control chamber 152, the pump inlet flow passage 170, the circulation pump 500, and the pump outlet flow passage 180.

Ink circulation that is completed in the discharging head 1 is thus performed. In the ink circulation, the circulation amount (flow amount) of the ink in the discharge module 300 is decided by the difference of the control pressure between the first pressure control chamber 122 and the second pressure control chamber 152. The pressure difference is set to obtain a circulation amount capable of suppressing an increase of the viscosity of ink near the orifice in the discharge module 300.

Also, ink as much as the amount consumed by printing is supplied from the ink tank 2 to the first pressure control chamber 122 via the filter 110 and the first valve chamber 121.

A mechanism for supplying ink as much as consumed ink will be described in detail. When the ink is decreased from the circulation path as much as the amount of ink consumed by printing, the ink in the first pressure control chamber 122 also decreases. The internal capacity of the first pressure control chamber 122 decreases along with the decrease of the ink in the first pressure control chamber 122. If the internal capacity of the first pressure control chamber 122 decreases, the communication port 191A is set in the open state, and the ink is supplied from the first valve chamber 121 to the first pressure control chamber 122. A pressure loss occurs in the supplied ink during passage from the first valve chamber 121 to the communication port 191A, and the ink in a positive pressure state changes to a negative pressure state when flowing into the first pressure control chamber 122. When the ink flows from the first valve chamber 121 into the first pressure control chamber 122, the internal capacity of the first pressure control chamber increases, and the communication port 191A is set in the closed state. In this way, the communication port 191A repeats the open state and the closed state in accordance with consumption of the ink. If the ink is not consumed, the communication port 191A maintains the closed state.

FIG. 15B schematically shows the flow of ink immediately after the printing operation is ended, and the circulation pump 500 is set in an OFF state (stop state). At the point of time when the printing operation is ended, and the circulation pump 500 is set in the OFF state, the pressure in the first pressure control chamber 122 and that in the second pressure control chamber 152 are the control pressures during the printing operation.

For this reason, ink movement as shown in FIG. 15B occurs in accordance with the pressure difference between the first pressure control chamber 122 and the second pressure control chamber 152. More specifically, the flow of ink continuously occurs such that the ink is supplied from the first pressure control chamber 122 to the discharge module 300 via the supply flow passage 130 and then flows to the second pressure control chamber 152 via the recovery flow passage 140. The flow of ink from the first pressure control chamber 122 to the second pressure control chamber 152 via the bypass flow passage 160 and the second valve chamber 151 also occurs.

Ink as much as the amount of ink moved from the first pressure control chamber 122 to the second pressure control chamber 152 by the flow of ink is supplied from the ink tank 2 to the first pressure control chamber 122 via the filter 110 and the first valve chamber 121. For this reason, the internal capacity of the first pressure control chamber 122 is kept constant. If the internal capacity of the first pressure control chamber 122 is constant, the spring force F1 of the valve spring 200, the spring force F2 of the pressure adjustment spring 220, the pressure receiving area S1 of the valve 190, and the pressure receiving area S2 of the pressure plate 210 are kept constant in accordance with the relationship of equation (2). For this reason, the pressure in the first pressure control chamber 122 is decided in accordance with the change of the pressure (gauge pressure) P1 in the first valve chamber 121. Hence, if the pressure P1 in the first valve chamber 121 does not change, the pressure P2 in the first pressure control chamber 122 is kept as the same as the control pressure during the printing operation.

On the other hand, the pressure in the second pressure control chamber 152 changes over time in accordance with the change of the internal capacity along with the flow-in of the ink from the first pressure control chamber 122. More specifically, during the time until the state shown in FIG. 15B changes to a state in which the communication port 191 is set in the closed state, and the second valve chamber 151 and the second pressure control chamber 152 are set in a noncommunicating state, as shown in FIG. 15C, the pressure in the second pressure control chamber 152 changes in accordance with equation (2). After that, the pressure plate 210 and the valve shaft 190a are set in a noncontact state, and the communication port 191 changes to the closed state.

Then, as shown in FIG. 15D, the ink flows from the recovery flow passage 140 into the second pressure control chamber 152. By the flow-in of ink, the pressure plate 210 and the flexible member 230 are displaced, and the pressure in the second pressure control chamber 152 changes in accordance with equation (4) until the internal capacity of the second pressure control chamber 152 is maximized. That is, the pressure rises.

Note that if the state shown in FIG. 15C is obtained, the flow of ink from the first pressure control chamber 122 to the second pressure control chamber 152 via the bypass flow passage 160 and the second valve chamber 151 does not occur. Hence, after the ink in the first pressure control chamber 122 is supplied to the discharge module 300 via the supply flow passage 130, only the flow to the second pressure control chamber 152 via the recovery flow passage 140 occurs. As described above, the movement of ink from the first pressure control chamber 122 to the second pressure control chamber 152 occurs in accordance with the pressure difference between the first pressure control chamber 122 and the second pressure control chamber 152. For this reason, if the pressure in the second pressure control chamber 152 equals the pressure in the first pressure control chamber 122, the movement of ink stops.

In a state in which the pressure in the second pressure control chamber 152 equals the pressure in the first pressure control chamber 122, the second pressure control chamber 152 expands up to the state shown in FIG. 15D. If the second pressure control chamber 152 expands, as shown in FIG. 15D, a storage portion capable of storing ink is formed in the second pressure control chamber 152. Note that the time of transition from the stop of the circulation pump 500 to the state shown in FIG. 15D can change depending on the shape and size of each flow passage and the characteristic of the ink, but the transition occurs in a time of about 1 to 2 min.

If the circulation pump 500 is driven from the state in which the ink is stored in the storage portion (the state shown in FIG. 15D), the ink in the storage portion is supplied to the first pressure control chamber 122 by the circulation pump 500. Thus, as shown in FIG. 15E, the ink amount in the first pressure control chamber 122 increases, and the flexible member 230 and the pressure plate 210 are displaced in the expanding direction. When driving of the circulation pump 500 is continuously performed, the state in the circulation path changes, as shown in FIG. 15A.

Note that in the above description, FIG. 15A has been described as an example during the printing operation. However, ink circulation may be performed without the printing operation, as described above. In this case as well, the flow of ink as shown in FIGS. 15A to 15E occurs in accordance with driving and stop of the circulation pump 500.

Also, as described above, in this embodiment, an example is used in which the communication port 191B of the second pressure adjustment mechanism 150 is set in the open state when the ink is circulated by driving the circulation pump 500, and set in the closed state when the ink circulation is stopped. However, the present invention is not limited to this. The control pressure may be set such that even if the ink is circulated by driving the circulation pump 500, the communication port 191B of the second pressure adjustment mechanism 150 is set in the closed state. This will be described below in detail.

The bypass flow passage 160 that connects the first pressure adjustment mechanism 120 and the second pressure adjustment mechanism 150 is provided such that, for example, if a negative pressure generated in the circulation path is higher than a predetermined value, it is prevented from affecting the discharge module 300. If the characteristic (for example, viscosity) of ink changes due to a change of an environmental temperature, the pressure loss in the circulation path also changes.

For example, if the viscosity of ink lowers, the pressure loss in the circulation path decreases, and the negative pressure in the circulation path may be higher than a predetermined value. If the negative pressure in the discharge module 300 is higher than a predetermined value, outside air may be drawn from the orifice 13 into the circulation path and break the meniscus of the orifice 13, and it may be impossible to perform normal discharge. Hence, in this embodiment, the bypass flow passage 160 is formed in the circulation path. When the bypass flow passage 160 is provided, if the negative pressure is higher than the predetermined value, ink flows to the bypass flow passage 160 as well, and the pressure in the discharge module 300 can be maintained constant.

Hence, for example, the communication port 191 of the second pressure adjustment mechanism 150 may be configured to obtain a control pressure for maintaining the closed state even during driving of the circulation pump 500. If the negative pressure is higher than the predetermined value, the control pressure of the second pressure adjustment mechanism may be set such that the communication port 191 of the second pressure adjustment mechanism 150 is set in the open state.

Also, a pressure variation in the circulation path may be caused by the discharge operation of the discharge element 15 as well. This is because along with the discharge operation, a force of drawing ink into a pressure chamber is generated. Hence, for example, even if the communication port 191 of the second pressure adjustment mechanism 150 is configured to be set in the closed state during driving of the circulation pump 500, the communication port 191 may be set in the open state in association with the discharge operation.

For example, if printing with a high printing duty is continued, the negative pressure in the pressure chamber rises. If the pressure in the pressure chamber rises, the ink flows back from the side of the recovery flow passage 140 as well into the pressure chamber (orifice 13). By this backflow, the ink in the second pressure control chamber 152 decreases, and the second pressure control chamber 152 is reduced. As a result, the communication port 191 of the second pressure adjustment mechanism 150 is set in the open state. In this case, the ink in the supply flow passage 130 and the ink in the recovery flow passage 140 are filled and discharged to the pressure chamber.

Note that the backflow of ink that occurs in case where the printing duty is high is a phenomenon that occurs because the bypass flow passage 160 is provided. In the above-described explanation, an example in which the communication port 191 of the second pressure adjustment mechanism is set in the open state in accordance with the backflow of ink has been described. However, the backflow of ink may occur in a state in which the communication port 191 of the second pressure adjustment mechanism is in the open state. Also, even in a configuration without the second pressure adjustment mechanism, the backflow of ink can occur if the bypass flow passage 160 is provided.

### <Flow of Ink in Discharge Unit>

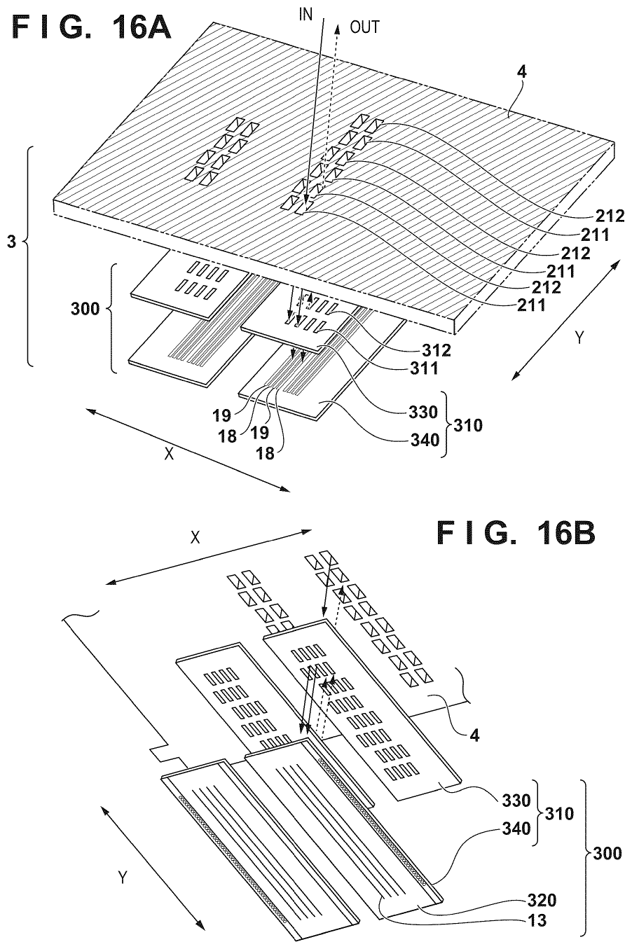

FIGS. 16A and 16B are schematic views showing a circulation path corresponding to one ink color in the discharge unit 3. FIG. 16A is an exploded perspective view showing the discharge unit 3 viewed from the side of the first support member 4, and FIG. 16B is an exploded perspective view showing the discharge unit 3 viewed from the side of the discharge module 300.

Note that arrows shown with IN/OUT in FIGS. 16A and 16B indicate the flows of ink. The flow of ink corresponding to only one color will be described, and this also applies to the other colors. To make the drawings easy to see, the second support member 7 and the electric wiring member 5 are omitted. These are omitted in the following description as well.

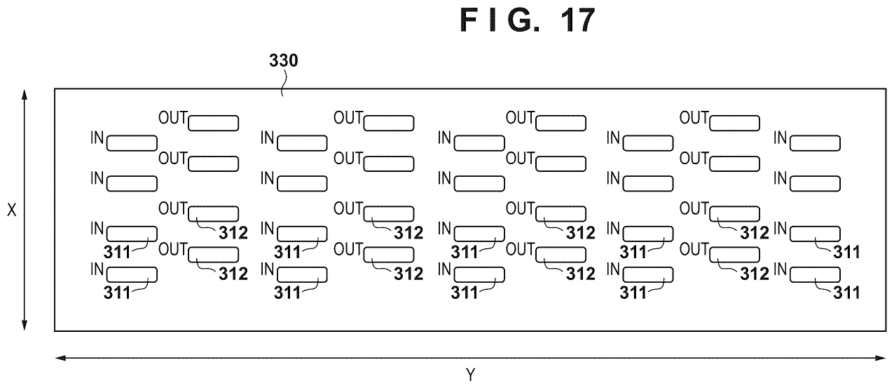

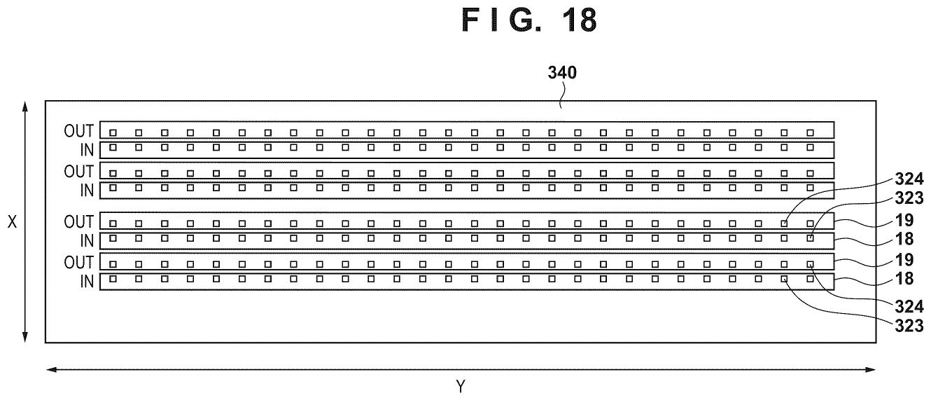

The first support member 4 shown in FIG. 16A shows a cross section corresponding to a sectional view taken along a line XI-XI in FIG. 6A. The discharge module 300 includes a discharge element substrate 340 and an opening plate 330. FIG. 17 is a view showing the opening plate 330, and FIG. 18 is a view showing the discharge element substrate 340.

The ink is supplied from the circulation unit 54 to the discharge unit 3 via the joint member 8 (see FIG. 6). The path of ink after it passes through the joint member 8 until it returns to the joint member 8 will be described. Note that the joint member 8 is omitted in the following drawings.

The discharge module 300 includes the discharge element substrate 340 and the opening plate 330. The discharge module 300 is formed by overlaying and joining these such that the flow passages of inks communicate, and is supported by the first support member 4. The discharge module 300 is supported by the first support member 4, thereby forming the discharge unit 3. The discharge element substrate 340 includes the orifice forming member 320. The orifice forming member 320 includes a plurality of orifice arrays in which the plurality of orifices 13 are arrayed, and a part of ink supplied via the ink flow passage in the discharge module 300 is discharged from the orifices 13. Note that the ink that is not discharged is recovered via the ink flow passage in the discharge module 300.

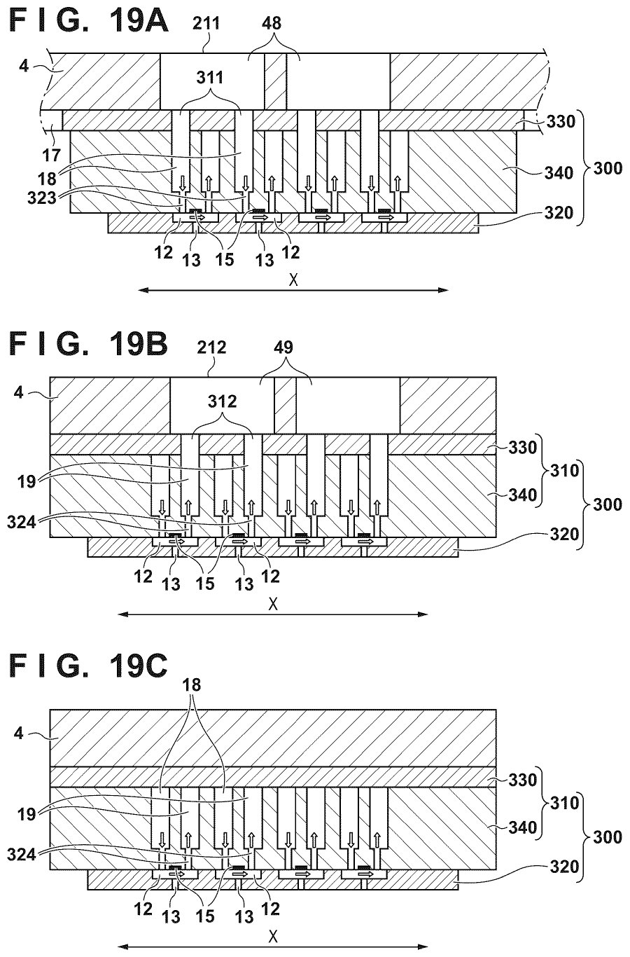

As shown in FIGS. 16A, 16B, and 17, the opening plate 330 includes a plurality of arrayed ink supply ports 311 and a plurality of arrayed ink recovery ports 312. As shown in FIGS. 18 and 19A to 19C, the discharge element substrate 340 includes a plurality of arrayed supply connection flow passages 323 and a plurality of arrayed recovery connection flow passages 324. The discharge element substrate 340 further includes the individual supply flow passages 18 that communicate with the plurality of supply connection flow passages 323 and the individual recovery flow passages 19 that communicate with the plurality of recovery connection flow passages 324. The ink flow passages in the discharge unit 3 are formed by making the ink supply flow passages 48 and the ink recovery flow passages 49 (see FIG. 6A) provided in the first support member 4 and the flow passages provided in the discharge module 300 communicate with each other. Support member supply ports 211 are cross-section openings that form the ink supply flow passages 48, and support member recovery ports 212 are cross-section openings that form the ink recovery flow passages 49.

Ink to be supplied to the discharge unit 3 is supplied from the circulation unit 54 (see FIG. 6A) to the ink supply flow passage 48 (see FIG. 6A) of the first support member 4. The ink that flows via the support member supply port 211 in the ink supply flow passage 48 is supplied to the individual supply flow passage 18 of the discharge element substrate 340 via the ink supply flow passage 48 (see FIG. 6A) and the ink supply port 311 of the opening plate 330 and then flows into the supply connection flow passage 323. The path to this point is the supply side flow passage. After that, the ink flows to the recovery connection flow passage 324 of the recovery side flow passage via the pressure chamber 12 (see FIG. 6B) of the orifice forming member 320.

In the recovery side flow passage, the ink that flows into the recovery connection flow passage 324 flows to the individual recovery flow passage 19. After that, the ink flows from the individual recovery flow passage 19 to the ink recovery flow passage 49 of the first support member 4 via the ink recovery port 312 of the opening plate 330, and is recovered by the circulation unit 54 via the support member recovery port 212.

Regions of the opening plate 330 where the ink supply ports 311 and the ink recovery ports 312 do not exist correspond to regions to partition the support member supply ports 211 and the support member recovery ports 212 in the first support member 4. In the regions, the first support member 4 has no openings. These regions are used as adhesion regions when adhering the discharge module 300 and the first support member 4.

Referring to FIG. 17, in the opening plate 330, a plurality of arrays of openings arrayed in the X direction are provided in the Y direction, and the openings for supply (IN) and the openings for recovery (OUT) are arrayed alternately in the Y direction such that these are shifted in the X direction by a half pitch.

Referring to FIG. 18, in the discharge element substrate 340, the individual supply flow passages 18 communicating with the plurality of supply connection flow passages 323 arrayed in the Y direction and the individual recovery flow passages 19 communicating with the plurality of recovery connection flow passages 324 arrayed in the Y direction are alternately arrayed in the X direction. The individual supply flow passages 18 and the individual recovery flow passages 19 are divided for each ink type, and the arrangement number of individual supply flow passages 18 and individual recovery flow passages 19 is decided in accordance with the number of orifice arrays of each color. The supply connection flow passages 323 and the recovery connection flow passages 324 are also arranged as many as the number of orifices 13. Note that these elements need not always be in a one-to-one correspondence, and one supply connection flow passage 323 and one recovery connection flow passage 324 may correspond to a plurality of orifices 13.

The discharge module 300 is formed by overlaying and joining the opening plate 330 and the discharge element substrate 340 such that the flow passages of inks communicate with each other, and is supported by the first support member 4, thereby forming the ink flow passages including the supply flow passages and the recovery flow passages described above.

FIGS. 19A to 19C are sectional views showing the flow of ink in different parts of the discharge unit 3. FIG. 19A shows a cross section of a part in which the ink supply flow passages 48 and the ink supply ports 311 in the discharge unit 3 communicate. FIG. 19B shows a cross section of a part in which the ink recovery flow passages 49 and the ink recovery ports 312 in the discharge unit 3 communicate. FIG. 19C shows a cross section of a part in which the ink supply ports 311 and the ink recovery ports 312 do not communicate with the flow passages in the first support member 4.

In the supply flow passage for supplying the ink, as shown in FIG. 19A, the ink is supplied from a portion where the ink supply flow passage 48 of the first support member 4 and the ink supply port 311 of the opening plate 330 overlap and communicate. In the recovery flow passage for recovering the ink, as shown in FIG. 19B, the ink is recovered from a portion where the ink recovery flow passage 49 of the first support member 4 and the ink recovery port 312 of the opening plate 330 overlap and communicate. As shown in FIG. 19C, in the discharge unit 3, regions without openings in the opening plate 330 partially exist. In such a region, ink supply and recovery are not performed, and ink supply is performed in regions where the ink supply ports 311 are provided, as shown in FIG. 19A, and ink recovery is performed in regions where the ink recovery ports 312 are provided, as shown in FIG. 19B.

Note that in this embodiment, a configuration using the opening plate 330 has been described as an example, but a form in which the opening plate 330 is not used is also possible. For example, a configuration in which flow passages corresponding to the ink supply flow passages 48 and the ink recovery flow passages 49 are formed in the first support member 4, and the discharge element substrate 340 is joined to the first support member 4 may be employed.

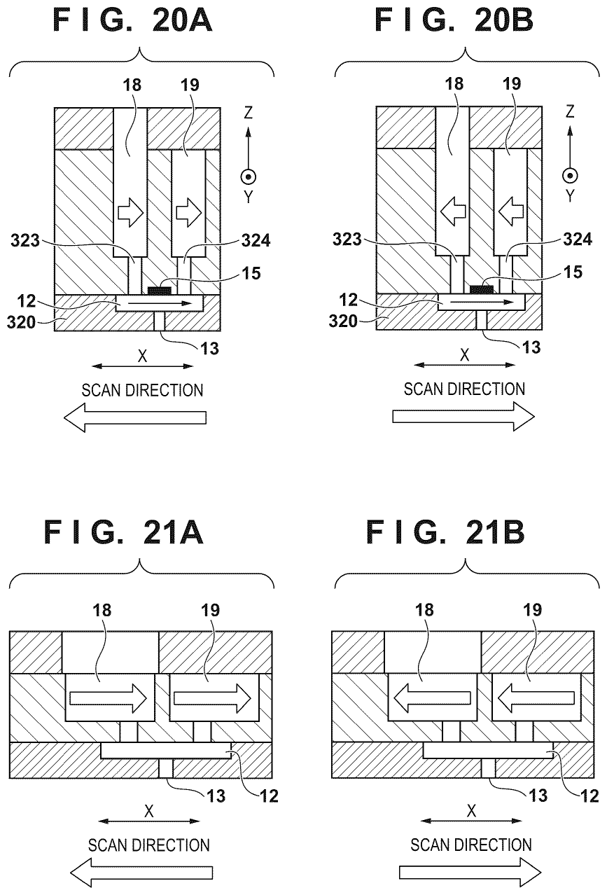

FIGS. 20A and 20B are sectional views concerning the vicinity of the orifice 13 in the discharge module 300. FIGS. 21A and 21B are sectional views showing a discharge module of a comparative example in which the individual supply flow passage 18 and the individual recovery flow passage 19 are expanded in the X direction. Note that thick arrows shown in the individual supply flow passage 18 and the individual recovery flow passage 19 in FIGS. 20A, 20B, 21A, and 21B indicate swing of ink in a form using the serial type liquid discharge apparatus 50. The ink supplied to the pressure chamber 12 via the individual supply flow passage 18 and the supply connection flow passage 323 is discharged from the orifice 13 by driving the discharge element 15. If the discharge element 15 is not driven, the ink is recovered from the pressure chamber 12 to the individual recovery flow passage 19 via the recovery connection flow passage 324 that is a recovery flow passage.

When discharging the circulated ink in the form using the serial type liquid discharge apparatus 50, the ink discharge is not a little affected by the swing of ink in the ink flow passage caused by the scan of the discharging head 1.

More specifically, the influence of swing of ink in the ink flow passage may appear as the difference of the ink discharge amount or a deviation of the discharge direction. If the individual supply flow passage 18 and the individual recovery flow passage 19 each have a sectional shape wide in the X direction that is the scan direction, as shown in FIGS. 21A and 21B, the ink in the individual supply flow passage 18 and the individual recovery flow passage 19 readily receives an inertial force in the scan direction, and large swing occurs in the ink. As a result, the swing of ink may affect ink discharge from the orifice 13. Also, if the individual supply flow passage 18 and the individual recovery flow passage 19 are extended in the X direction, the distance between the colors increases, and the printing efficiency may lower.

Both the individual supply flow passage 18 and the individual recovery flow passage 19 according to this embodiment extend in the Y direction in the cross section shown in FIGS. 20A and 20B, and also extend in the Z direction perpendicular to the X direction that is the scan direction. With this configuration, the flow passage widths of the individual supply flow passage 18 and the individual recovery flow passage 19 in the scan direction can be made small. The flow passage widths of the individual supply flow passage 18 and the individual recovery flow passage 19 in the scan direction are made small, thereby reducing the swing of ink caused by the inertial force (thick solid arrows in FIGS. 20A and 20B) that acts on the ink in the individual supply flow passage 18 and the individual recovery flow passage 19 during scan and acts on a side opposite to the scan direction. This can suppress the influence of the swing of ink on ink discharge. Also, when the individual supply flow passage 18 and the individual recovery flow passage 19 extend in the Z direction, the sectional areas of these are increased, and a flow passage pressure loss is reduced.

As described above, when the flow passage widths of the individual supply flow passage 18 and the individual recovery flow passage 19 in the scan direction are small, the swing of ink in the individual supply flow passage 18 and the individual recovery flow passage 19 at the time of scan is reduced. However, the swing is not eliminated. In this embodiment, to suppress the difference of discharge between ink types, which may be caused even by small swing, the individual supply flow passage 18 and the individual recovery flow passage 19 are configured to be arranged at positions where these overlap each other in the X direction.

As described above, in this embodiment, the supply connection flow passage 323 and the recovery connection flow passage 324 are provided in correspondence with the orifice 13, and the supply connection flow passage 323 and the recovery connection flow passage 324 are arranged side by side in the X direction while sandwiching the orifice 13. For this reason, there is a portion where the individual supply flow passage 18 and the individual recovery flow passage 19 do not overlap in the X direction, and if the correspondence relationship between the supply connection flow passage 323 and the recovery connection flow passage 324 in the X direction cannot be satisfied, the ink flow in the X direction in the pressure chamber 12 and discharge of the ink are affected. If the influence of the swing of ink is added, this may further affect the ink discharge of each orifice.

For this reason, when the individual supply flow passage 18 and the individual recovery flow passage 19 are arranged at positions where these overlap in the X direction, the ink substantially similarly swings in the individual supply flow passage 18 and the individual recovery flow passage 19 at the time of scan at any position in the Y direction in which the orifices 13 are arrayed. As a result, the pressure difference that occurs in the pressure chamber 12 between the side of the individual supply flow passage 18 and the side of the individual recovery flow passage 19 does not largely vary, and stable discharge can be performed.

In some of the discharging heads 1 that circulate ink, the flow passage for supplying ink to the discharging head 1 and the flow passage for recovering the ink are formed by the same flow passage. In this embodiment, however, the individual supply flow passage 18 and the individual recovery flow passage 19 are different flow passages. The supply connection flow passage 323 and the pressure chamber 12 communicate with each other, the pressure chamber 12 and the recovery connection flow passage 324 communicate with each other, and ink is discharged from the orifice 13 of the pressure chamber 12.

That is, the pressure chamber 12 that is the path connecting the supply connection flow passage 323 and the recovery connection flow passage 324 includes the orifice 13. For this reason, an ink flow from the side of the supply connection flow passage 323 to the side of the recovery connection flow passage 324 occurs in the pressure chamber 12, and the ink in the pressure chamber 12 is efficiently circulated. If the ink in the pressure chamber 12 is efficiently circulated, the ink in the pressure chamber 12, which is readily affected by evaporation of the ink from the orifice 13, can be kept in a fresh state.

Also, the two flow passages, that is, the individual supply flow passage 18 and the individual recovery flow passage 19 communicate with the pressure chamber 12. For this reason, if it is necessary to discharge ink in a large flow amount, the ink can be supplied from both flow passages. That is, as compared to a configuration in which supply and recovery of ink are performed by only one flow passage, the configuration according to this embodiment can not only implement efficient circulation but also cope with discharge of the ink in a large flow amount.

Also, if the individual supply flow passage 18 and the individual recovery flow passage 19 are arranged at close positions in the X direction, the influence of the swing of ink is hardly generated. Preferably, the distance between the flow passages is 75 μm to 100 μm.

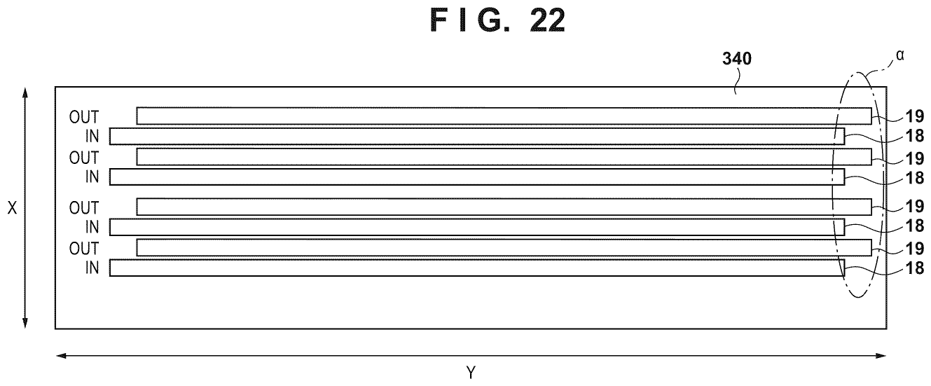

FIG. 22 is a view showing the discharge element substrate 340 according to a comparative example. Note that the supply connection flow passages 323 and the recovery connection flow passages 324 are omitted in FIG. 22. Since the ink that has received thermal energy by the discharge element 15 in the pressure chamber 12 flows into the individual recovery flow passage 19, ink whose temperature is higher than that of the ink in the individual supply flow passage 18 flows in the individual recovery flow passage 19. At this time, in the comparative example, there exists a portion of the discharge element substrate 340 in the X direction, where only the individual recovery flow passages 19 exist, like a portion a surrounded by an alternate long and short dashed line in FIG. 22. In this case, the temperature may locally become high in this portion, resulting in temperature unevenness in the discharge module 300 and an influence on the discharge.

Ink whose temperature is lower than that of the ink in the individual recovery flow passage 19 flows in the individual supply flow passage 18. For this reason, if the individual supply flow passage 18 and the individual recovery flow passage 19 are adjacent, the temperatures partially cancel each other between the individual supply flow passage 18 and the individual recovery flow passage 19, and a temperature rise can be suppressed near these. It is therefore preferable that the individual supply flow passage 18 and the individual recovery flow passage 19 have substantially the same length, and these exist at positions overlapping each other in the X direction and are adjacent to each other.

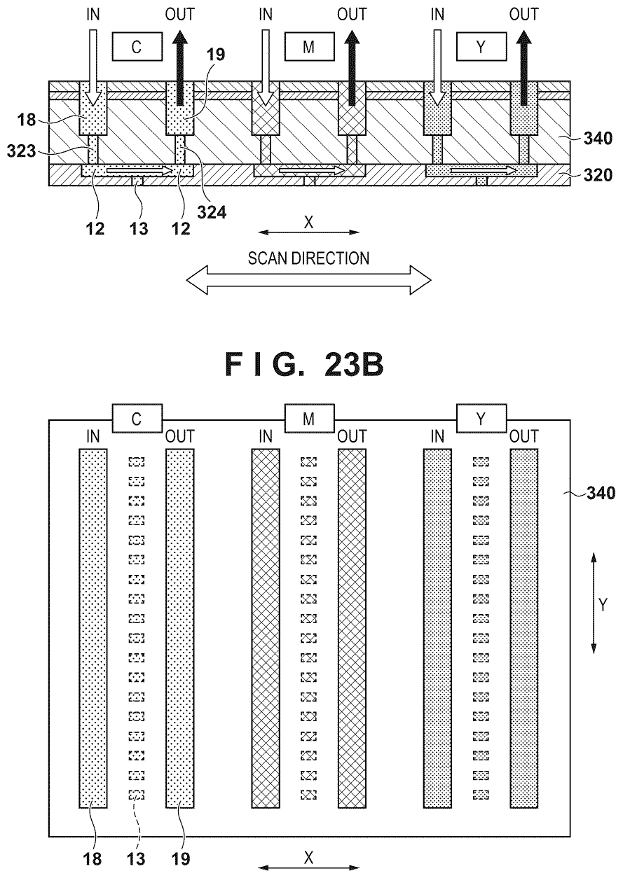

FIGS. 23A and 23B show the flow passage configuration of the discharging head 1 corresponding to inks of three colors, that is, cyan (C), magenta (M), and yellow (Y). As shown in FIG. 23A, the circulation flow passage is provided for each ink type in the discharging head 1. The pressure chambers 12 are provided along the X direction that is the scan direction of the discharging head 1. Also, as shown in FIG. 23B, the individual supply flow passages 18 and the individual recovery flow passages 19 are provided along orifice arrays in which the orifices 13 are arrayed, and are extended in the Y direction such that each orifice array is sandwiched between the individual supply flow passage 18 and the individual recovery flow passage 19.

### <Driving Control of Circulation Pump>

An example of driving control of the circulation pump 500 will be described. The circulation pump 500 is driven during a circulation period for circulating ink in the discharging head 1 and stopped except during the circulation period. The circulation period is started when a start condition is satisfied, and ended when an end condition is satisfied.

The start condition is, for example, reception of a print job from the host apparatus 400, and the end condition is, for example, completion of printing associated with the print job. In this case, the printing operation is included in the circulation period. Also, the start condition is that the liquid discharge apparatus 50 is powered on, or a time without a printing operation after power-on reaches a predetermined time, and the end condition is, for example, the elapse of a predetermined time. Also, the start condition is a start instruction of the user, and the end condition is, for example, the elapse of a predetermined time, or an end instruction of the user. In this case, an increase of the viscosity of ink in the discharging head 1 can be suppressed.

If the circulation pump 500 is driven at high power during the circulation period, sedimentation of a solid component in the ink can be eliminated in a short time. However, this increases the load on the circulation pump 500, resulting in a decrease of the life of the circulation pump 500 or an increase of power consumption. In this embodiment, the driving condition of the circulation pump 500 is switched to change the flow velocity of ink halfway through the circulation period.

When the circulation pump 500 is driven such that the flow velocity of ink becomes relatively high, elimination of sedimentation of the solid component in the ink is promoted. When the circulation pump 500 is driven such that the flow velocity of ink becomes relatively low, sedimentation of the solid component in the ink can be suppressed while suppressing the load on the circulation pump 500. By this control, elimination of sedimentation of the solid component in a short time and reduction of the load on the circulation pump 500 can simultaneously be implemented.

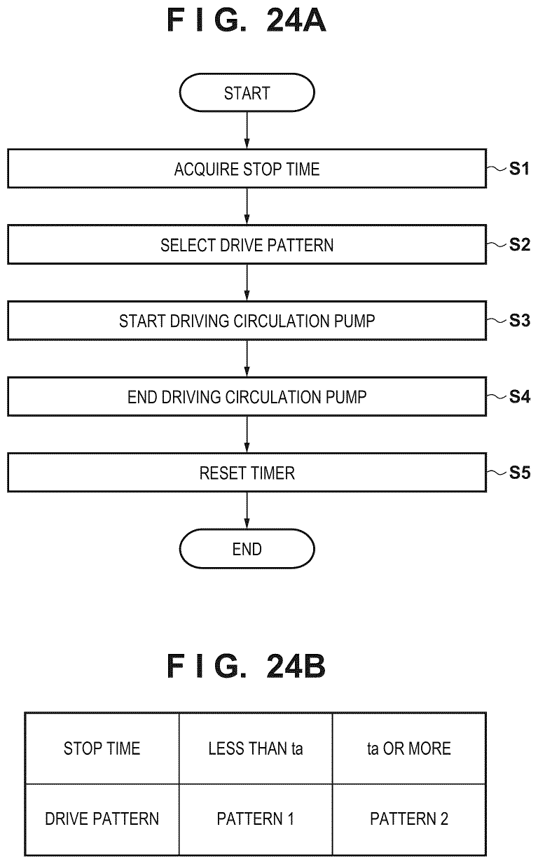

FIG. 24A is a flowchart showing an example of processing of the CPU 100, and shows an example of driving control of the circulation pump 500. This processing is executed when the start condition is satisfied. In step S1, a circulation stop time (the stop time of the circulation pump 500) from the preceding circulation period to the current circulation period is acquired. In this embodiment, this time is counted by the timer 23. In step S2, a selection table stored in the ROM 101 is read out, and a drive pattern of the circulation pump 500 in the current circulation period is selected. FIG. 24B shows an example of selected patterns. If the stop time acquired in step S1 is less than a threshold time ta, pattern 1 is selected. If the stop time acquired in step S1 is equal to or more than the threshold time ta, pattern 2 is selected.

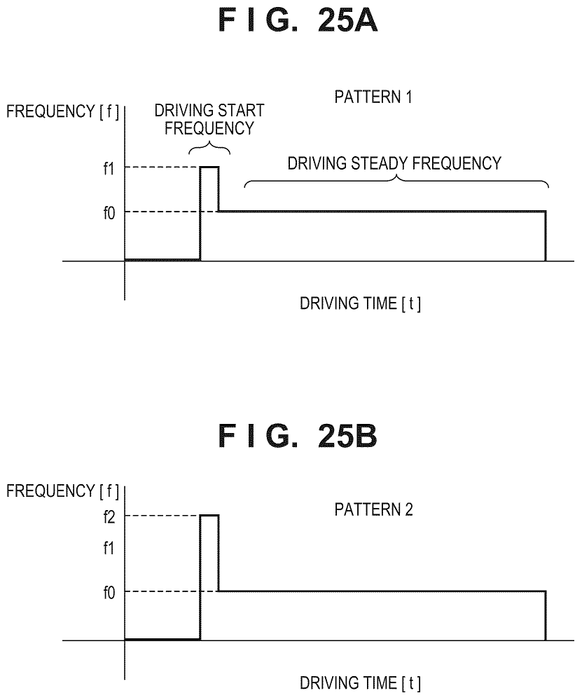

FIG. 25A is a timing chart of control of pattern 1, and FIG. 25B is a timing chart of control of pattern 2. In the example shown in FIGS. 25A and 25B, a driving frequency is exemplified as an example of the driving condition of the circulation pump 500. If the driving frequency of the circulation pump 500 is high, the flow velocity of ink is high. If the driving frequency of the circulation pump 500 is low, the flow velocity of ink is low.

In pattern 1, the driving frequency is set to f1 (driving start frequency) for a predetermined time from the start of driving and then set to f0 (<f1) (driving steady frequency). Before the start of the circulation period, sedimentation of the solid component in the ink progresses. Immediately after the start of the circulation period, the driving frequency is set high to increase the flow velocity of ink, thereby promoting elimination of sedimentation. After the elapse of a predetermined time, the driving frequency is lowered to reduce the flow velocity of ink, and circulation is done in the state. This can suppress the load on the circulation pump 500.

In pattern 2 as well, the driving frequency is set to f2 for a predetermined time from the start of driving and then set to f0 (<f2). As compared to the driving frequency f1 of pattern 1, the driving frequency f2 of pattern 2 holds a relationship given by f2>f1. If the stop time is long, sedimentation of the solid component in the ink progresses more than in a case where the stop time is short. Hence, in pattern 2, the driving frequency immediately after the start of the circulation period is set higher to increase the flow velocity of ink, thereby promoting elimination of sedimentation.

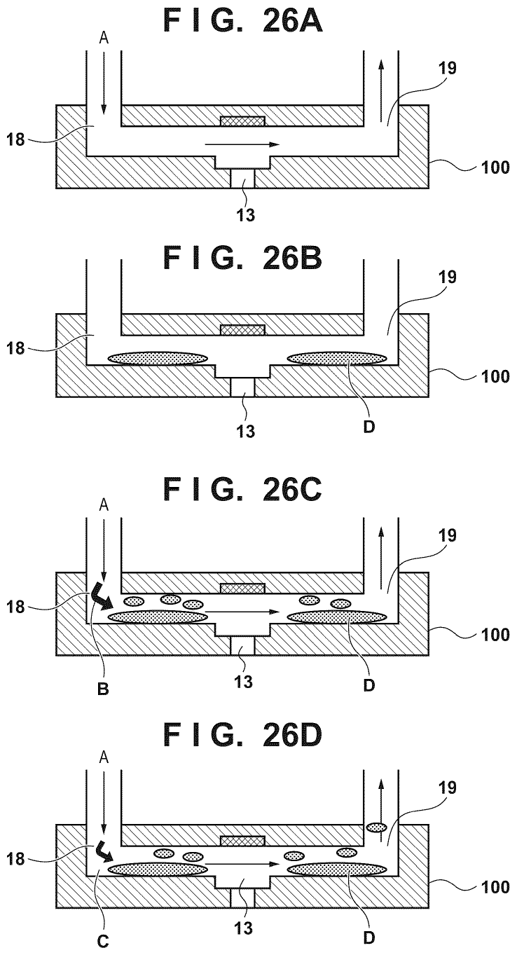

FIGS. 26A to 26D are explanatory views showing an example of an ink flowing mode in a nozzle (the periphery of the orifice 13). FIG. 26A shows a state in which the ink is circulated. The ink is circulated in the direction of an arrow A, and sedimentation of the solid component in the ink does not occur in the circulating state. FIG. 26B shows a state in which the circulation is stopped. If the circulation is stopped, and the left state continues, the solid component in the ink is sedimented and appears as a deposit D on a flat portion. The longer the stop time is, the larger the amount of the deposit D is.

FIG. 26C is a schematic view when the driving start frequency of the circulation pump 500 is set higher than the driving steady frequency, and ink circulation is started. When ink circulation is started in the direction of the arrow A, an instantaneously large force indicated by an arrow B acts on the deposit D. The sedimented deposit D is set in a floating state. FIG. 26D shows a state in which the driving condition of the circulation pump 500 is changed to drive it at the driving steady frequency. The deposit D in the floating state is flowed by a relatively small force (arrow C), and the sedimentation is eliminated.

Referring back to FIG. 24A, in step S3, driving of the circulation pump 500 is started by a drive pattern selected in step S2. The circulation of the ink is thus started in the discharging head 1. If the end condition of the circulation period is satisfied, driving of the circulation pump 500 is ended in step S4. In step S5, the timer 23 is reset, and the stop time is newly counted.

Note that the selection table or the drive pattern may be the same regardless of the ink type. However, the selection table or the drive pattern may be set for each ink type, and this can appropriately eliminate sedimentation of the solid component in accordance with the characteristic of an ink type.

### <Relationship Between Driving Time and Effect>

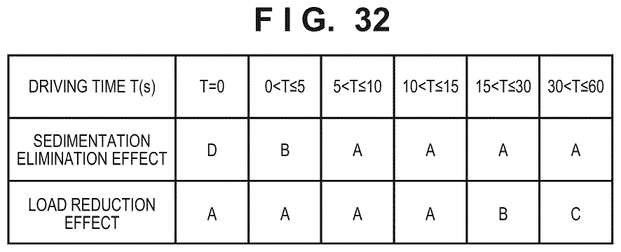

FIG. 32 illustrates results of an experiment in which the driving time T (seconds) at the driving frequency f1 are made to differ for control of pattern 1. For each range of driving time T, the deposit sedimentation elimination effect and the load reduction effect on the circulation pump 500 were evaluated at four levels, A to D. A indicates a large effect, B a moderate effect, C a small effect, and D no effect. The driving frequency f0 is 20 Hz and the driving frequency f1 is 60 Hz.

In the case of no driving at the driving frequency f1 (T=0), there is no sedimentation elimination effect, and the load reduction effect is high. In the case where the driving time T is greater than 0 (specifically, a minimum of 1/60 seconds) and 5 seconds or less, the sedimentation elimination effect is moderate (B evaluation), and the load reduction effect is high (A evaluation). In other words, by driving the circulation pump 500 one pulse or more ( 1/60 seconds or more), the sedimentation elimination effect appeared. If the driving time Tis longer, the sedimentation elimination effect becomes higher, and the load on the circulation pump 500 becomes larger. From the perspective of the load reduction effect, the driving time T is preferably 30 seconds or less, in particular, 15 seconds or less.

The driving time of the driving frequency f2 in the control of the pattern 2 is thought to have a similar tendency, and the driving time thereof may also be set similarly to the driving time T of the driving frequency f1. For example, the driving time T is preferably 1/f2 or more, and 30 seconds or less, in particular, 15 seconds or less.

The time of the circulation period is set to, for example, 1/30 or more of the threshold time ta. In the case where the threshold time ta is, for example, 1 hour, the circulation period is 2 minutes or more. In the case where the circulation period is 2 minutes and pattern 1 is selected, the driving time T of the driving frequency f1 is, as one example, 1/60 seconds or more and 20 seconds or less, as described above. In the case where the threshold ta is made to be, for example, 30 minutes, the circulation period is, for example, 1 minute or more. The upper limit of the circulation period is, for example, 5 minutes or less, and in particular, 3 minutes or less.

### Another Example 1 of Drive Pattern

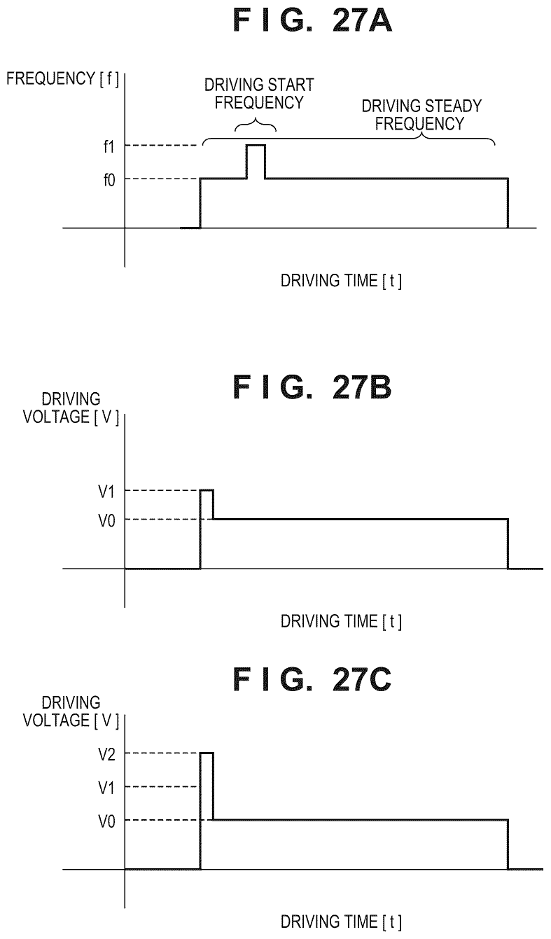

In the example shown in FIGS. 25A and 25B, the driving frequency of the circulation pump 500 immediately after the start of the circulation period is set to the driving start frequency. However, the driving frequency may be set to the driving steady frequency immediately after the start, then set to the driving start frequency, and then set to the driving steady frequency again. FIG. 27A shows an example. The driving condition (driving frequency) of the circulation pump 500 is switched a plurality of times. The driving start frequency may be set in a time zone included in the first half of the circulation period, particularly, the first ¼ period or the first ⅛ period.

### Another Example 2 of Drive Pattern

In the example shown in FIGS. 25A and 25B, the driving frequency is exemplified as the driving condition of the circulation pump 500. However, another condition may be used. FIGS. 27B and 27C show an example in which a driving voltage is switched as the driving condition. If the driving voltage of the circulation pump 500 is high, the flow velocity of ink is high. If the driving voltage of the circulation pump 500 is low, the flow velocity of ink is low.

FIG. 27B shows an example used as pattern 1 in the selection table shown in FIG. 24B. In this example, the driving voltage is set to V1 during a predetermined time from the start of driving and then set to V0 (<V1). Immediately after the start of the circulation period, the driving voltage is set high to increase the flow velocity of ink, thereby promoting elimination of sedimentation. After the elapse of the predetermined time, the driving voltage is lowered to reduce the flow velocity of ink, and circulation is done in the state. This can suppress the load on the circulation pump 500.

FIG. 27C shows an example used as pattern 2 in the selection table shown in FIG. 24B. In this example as well, the driving voltage is set to V2 during a predetermined time from the start of driving and then set to V0 (<V2). As compared to the driving voltage V1 of pattern 1, the driving voltage V2 of pattern 2 holds a relationship given by V2>V1. If the stop time is long, sedimentation of the solid component in the ink progresses more than in a case where the stop time is short. Hence, in pattern 2, the driving voltage immediately after the start of the circulation period is set higher to increase the flow velocity of ink, thereby promoting elimination of sedimentation.

### Another Example 3 of Drive Pattern

As the difference between the drive patterns, the height difference between driving frequencies is exemplified in the example shown in FIGS. 25A and 25B, and the height difference between driving voltages is exemplified in the example shown in FIGS. 27B and 27C. However, the height may be the same, and the time may be different. Also, in the selection table shown in FIG. 24B, one drive pattern is selected from two types of drive patterns. However, one drive pattern may be selected from three or more types of drive patterns.

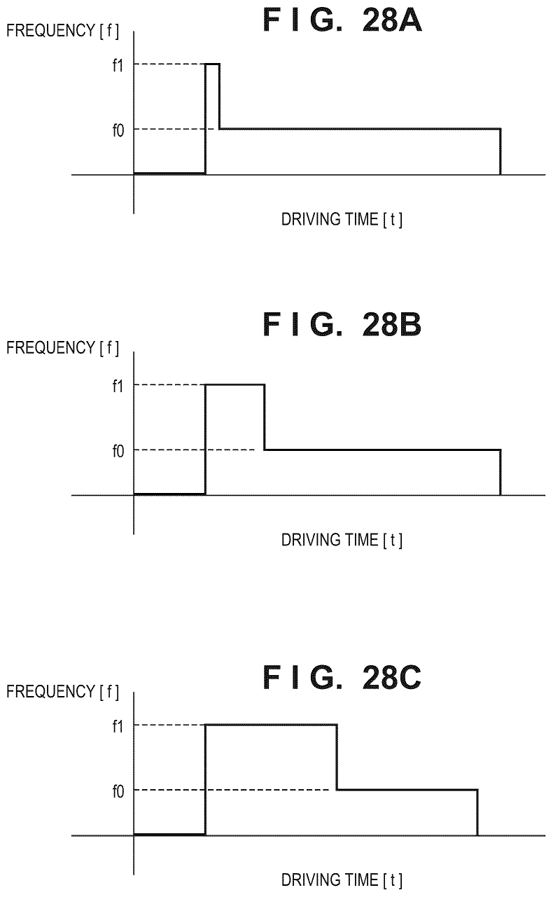

FIGS. 28A to 28C exemplify three types of drive patterns, and processing of selecting one drive pattern from the three types of drive patterns in the circulation period is assumed. The three types of drive patterns have the same height of the driving start frequency (f1), but the length of the driving time of the circulation pump 500 at the driving start frequency is different. The length of the driving time is shortest in the example shown in FIG. 28A, and longest in the example shown in FIG. 28C. If the stop time is relatively short, the example shown in FIG. 28A is selected. If the stop time is relatively long, the example shown in FIG. 28C is selected. If the stop time is medium, the example shown in FIG. 28B is selected.

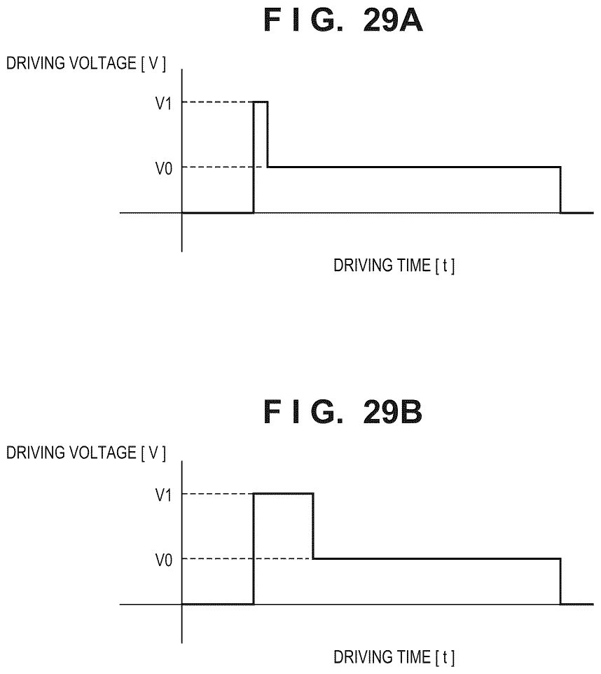

FIGS. 29A and 29B exemplify two types of drive patterns, and processing of selecting one drive pattern from the two types of drive patterns in the circulation period is assumed. The two types of drive patterns have the same height of the driving voltage at the start of driving (V1), but the length of the driving time of the circulation pump 500 at the driving voltage is different. The length of the driving time is shorter in the example shown in FIG. 29A, and longer in the example shown in FIG. 29B. If the stop time is relatively short, the example shown in FIG. 29A is selected. If the stop time is relatively long, the example shown in FIG. 29B is selected.

### Another Example of Drive Pattern Selection Method

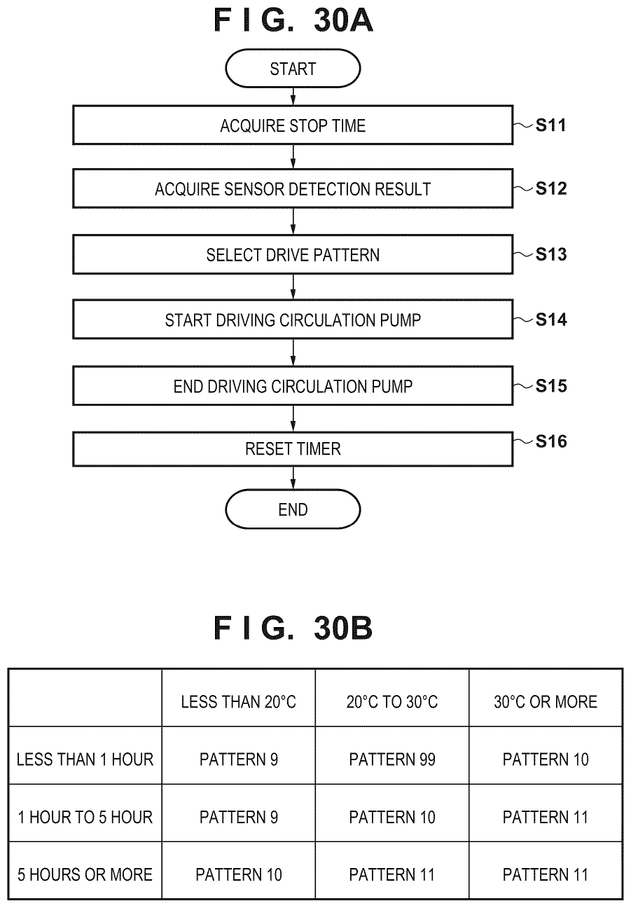

In the selection table shown in FIG. 24B, the drive pattern is selected in accordance with the stop time. However, the drive pattern may be selected in accordance with not only the stop time but also the environment around the liquid discharge apparatus 50. FIG. 30B shows an example. The example shown in FIG. 30B is an example in which one drive pattern is selected from three types of patterns 9 to 11 based on the stop time and the environmental temperature around the liquid discharge apparatus 50 detected by the temperature/humidity sensor 24. Stop times are classified into three types, that is, less than “1 hr”, “1 hr or more and less than 5 hrs”, and “5 hrs or more”. Environmental temperatures are classified into three types, that is, “less than 20° C.”, “20° C. or more and less than 30° C.”, and “30° C. or more”. It is assumed that the longer the stop time is, the more the sedimentation of the solid component progresses, and the higher the environmental temperature is, the more the sedimentation of the solid component progresses.

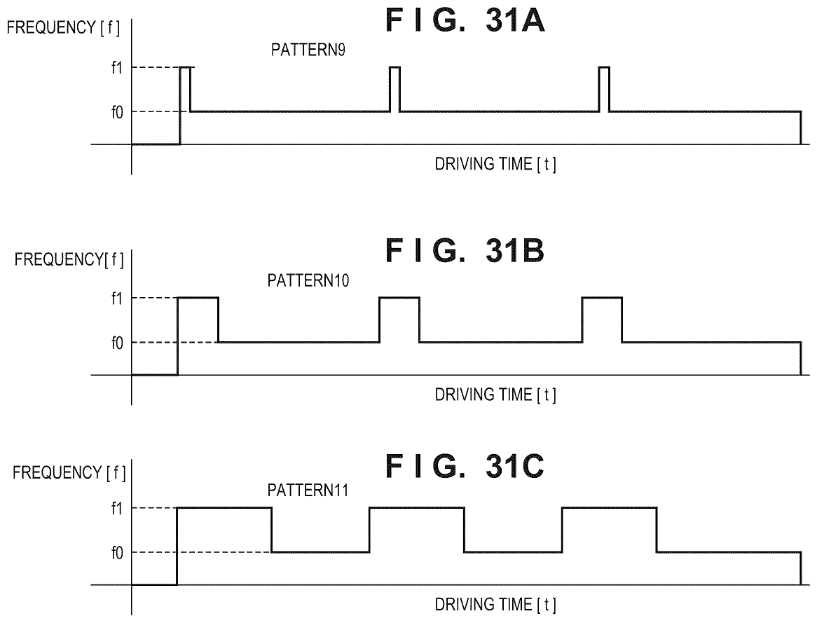

FIGS. 31A to 31C show drive patterns corresponding to patterns 9 to 11 in FIG. 30B. In all drive patterns, as the driving condition of the circulation pump 500, the driving frequency is switched between f1 and f0 (<f1) a plurality of times. In pattern 9 shown in FIG. 31A, one set time of the driving frequency f1 is shortest, and in pattern 11 shown in FIG. 31C, one set time of the driving frequency f1 is longest. Hence, the magnitude relationship between the capability of eliminating sedimentation of the solid component in the ink and the load on the circulation pump 500 in patterns 9 to 11 is given by pattern 9<pattern 10<pattern 11.

FIG. 30A shows an example of driving control of the circulation pump 500 corresponding to the selected pattern in FIG. 30B. This processing is executed when the start condition is satisfied. In step S11, a time (the stop time of the circulation pump 500) from the preceding circulation period to the current circulation period is acquired from the timer 23. In step S12, the temperature detection result (environmental temperature) of the temperature/humidity sensor 24 is acquired.

In step S13, a selection table (FIG. 30B) stored in the ROM 101 is read out. Based on the combination of the stop time acquired in step S11 and the environmental temperature acquired in step S12, the drive pattern of the circulation pump 500 in the current circulation period is selected from patterns 9 to 11.

In step S14, driving of the circulation pump 500 is started by the drive pattern selected in step S13. The circulation of the ink is thus started in the discharging head 1. If the end condition of the circulation period is satisfied, driving of the circulation pump 500 is ended in step S15. In step S16, the timer 23 is rest, and the stop time is newly counted.

Note that in this example, when selecting a drive pattern, the environmental temperature is taken into consideration. However, an environmental humidity around the liquid discharge apparatus 50 detected by the temperature/humidity sensor 24 may be taken into consideration. Alternatively, both the environmental temperature and the environmental humidity may be taken into consideration. Alternatively, when selecting a drive pattern, the temperature of the discharging head 1 detected by the head temperature sensor 25 may be taken into consideration. The temperature of the discharging head 1 substantially equals the ink temperature, and the driving condition of the circulation pump 500 may be set such that the higher the temperature is, the higher the flow velocity of ink is.

### OTHER EMBODIMENTS

In the above-described embodiment, the circulation pump 500 using a diaphragm mechanism has been exemplified. The circulation pump may use not the diaphragm but a different mechanism such as a tube pump that squeezes a tube physically by a roller. A plurality of circulation pumps may be used.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2023-118513, filed Jul. 20, 2023, and No. 2024-108398, filed Jul. 4, 2024, which are hereby incorporated by reference herein in their entirety.

What is claimed is:

1. A liquid discharge apparatus comprising:
a discharging head including a nozzle configured to discharge a liquid;
a circulation pump provided in the discharge head and configured to supply the liquid to the nozzle, the pump being configured to circulate the liquid; and
a control unit configured to control driving of the circulation pump,
wherein the control unit is configured to switch a driving condition of the circulation pump to change a flow velocity of the liquid during a circulation period of the liquid.

2. The apparatus according to claim 1, wherein
the driving condition includes a first driving condition and a second driving condition, and
the first driving condition is a driving condition for making the flow velocity higher than the second driving condition.

3. The apparatus according to claim 2, wherein
at a start of the circulation period, the control unit is configured to control driving of the circulation pump based on the first driving condition.

4. The apparatus according to claim 1, wherein
the control unit is configured to switch the driving condition a plurality of times during the circulation period.

5. The apparatus according to claim 1, wherein
the circulation pump includes a piezoelectric element as a driving source, and
the driving condition relates to a driving frequency of the piezoelectric element.

6. The apparatus according to claim 1, wherein
the circulation pump includes a piezoelectric element as a driving source, and
the driving condition relates to a driving voltage of the piezoelectric element.

7. The apparatus according to claim 1, wherein
the control unit is configured to drive the circulation pump during the circulation period in accordance with a drive pattern selected from a plurality of drive patterns.

8. The apparatus according to claim 7, wherein
the control unit is configured to select the drive pattern based on a circulation stop time from a preceding circulation period to a current circulation period.

9. The apparatus according to claim 8, further comprising a temperature sensor,
wherein the control unit is configured to select the drive pattern based on the circulation stop time and a temperature detection result of the temperature sensor.

10. The apparatus according to claim 9, wherein
the temperature sensor detects an environmental temperature around the liquid discharge apparatus.

11. The apparatus according to claim 9, wherein
the temperature sensor is provided in the discharging head.

12. The apparatus according to claim 7, wherein
the plurality of drive patterns include a first drive pattern and a second drive pattern,
the driving condition in the first drive pattern includes a first driving condition and a second driving condition,
the driving condition in the second drive pattern includes a third driving condition and a fourth driving condition, and
the first driving condition and the third driving condition are driving conditions for making the flow velocity higher than the second driving condition and the fourth driving condition.

13. The apparatus according to claim 12, wherein
the third driving condition is a driving condition for making the flow velocity higher than the first driving condition.

14. The apparatus according to claim 12, wherein
a time of driving the circulation pump based on the third driving condition in the second drive pattern is longer than a time of driving the circulation pump based on the first driving condition in the first drive pattern.

15. The apparatus according to claim 1, wherein
the liquid discharge apparatus is a printing apparatus configured to discharge ink as the liquid from the nozzle to a print medium.

16. The apparatus according to claim 2, wherein
a time of driving the circulation pump based the first driving condition is 1/60 seconds or more, and 30 seconds or less.

17. The apparatus according to claim 1, wherein
the circulation period is 2 minutes or more.

18. The apparatus according to claim 1, wherein
the control unit is configured to select a driving condition of the circulation pump based on whether or not a predetermined time elapses from a previous circulation period of the liquid,
each circulation period is set to 1/30 or more of the predetermined time.

19. A control method of a liquid discharge apparatus including a discharging head including a nozzle configured to discharge a liquid, and a circulation pump provided in the discharge head and configured to supply the liquid to the nozzle, the pump being configured to circulate the liquid, the control method comprising:
switching a driving condition of the circulation pump to change a flow velocity of the liquid during a circulation period of the liquid.

20. A non-transitory computer-readable storage medium storing a program configured to cause a computer to execute a control method of a liquid discharge apparatus including a discharging head including a nozzle configured to discharge a liquid, and a circulation pump provided in the discharge head and configured to supply the liquid to the nozzle, the pump being configured to circulate the liquid, the control method comprising:
switching a driving condition of the circulation pump to change a flow velocity of the liquid during a circulation period of the liquid.
